(19) United States
(12) Patent Application Publication
(10) Pub. No.: US 2014/0149867 A1
(43) Pub. Date: May 29, 2014

(54) WEB-BASED INTERACTIVE EXPERIENCE UTILIZING VIDEO COMPONENTS

(71) Applicant: RAPT MEDIA, INC., Boulder, CO (US)

(72) Inventors: Erika Trautman McCaddon, Boulder, CO (US); Cameron Joel McCaddon, Boulder, CO (US)

(73) Assignee: RAPT MEDIA, INC., Boulder, CO (US)

(21) Appl. No.: 14/167,570

(22) Filed: Jan. 29, 2014

Related U.S. Application Data
(63) Continuation of application No. 13/274,224, filed on Oct. 14, 2011.
(60) Provisional application No. 61/436,478, filed on Jan. 26, 2011.
(60) Provisional application No. 61/393,038, filed on Oct. 14, 2010.

(51) Int. Cl. G06F 3/0482; G06F 3/0486

(52) U.S. Cl. CPC G06F 3/0482; G06F 3/0486
USPC 715/723

(57) ABSTRACT

One embodiment may include apparatus, methods and/or systems for providing one or more interactive experiences over a network, such as the Internet, wherein the experiences include one or more of audio, video data, applications, feature, functions or other forms of content. In one embodiment, the experiences are accessed by one or more websites that include a plurality of interactive features, such as those for an interactive game. The interactive experience may include one or more content segments presented to the participants through which a story including several scenes may be presented. The content segments may include applications which provide a desired functionality, such providing direction on a map or otherwise. Additional and alternative interactivity, such as online analytics relating to the content may be analyzed, emails, phone calls or other communications to participants and/or editors may be provided and other forms of during and/or post experience interactivity may be provided.

### CROSS REFERENCE TO RELATED APPLICATIONS

The present application claims priority to U.S. Non-Provisional patent application Ser. No. 13/274,224 filed on Oct. 14, 2011, U.S. Provisional Patent Application No. 61/393,038 filed on 14 Oct. 2010 and to U.S. Provisional Patent Application No. 61/436,478, filed on 26 Jan. 2011, all of which were filed in the name of inventors Erika Trautman McCaddon and Cameron Joel McCaddon and are commonly entitled “Web Based Interactive Game Utilizing Video Components,” the contents of all of which are hereby incorporated by reference in their entirety. The present application is also related to Patent Cooperation Treaty Application Serial Number PCT/US2011/056453 filed on Oct. 14, 2011, in the name of inventors Erika Trautman McCaddon and Cameron Joel McCaddon, entitled “System and Method for Creating and Analyzing Interactive Experiences,” the contents of which are hereby incorporated by reference in its entirety.

### TECHNICAL FIELD

The various embodiments discussed herein relate generally to network-based interactive experiences, the providing of interactive experiences, such as an interactive game, advertisement, program or other rich media content, over a network by utilizing one or more video components or other forms of audio, video or data content or applications.

### SUMMARY

The various embodiments discussed herein are directed to apparatus, systems, and methods for creating interactive experiences.

In at least one embodiment, an apparatus provides a tool for editing an interactive experience. The apparatus includes a processor and a machine-readable storage medium communicatively coupled to the processor. The machine-readable storage medium is configured to store a first computer-executable code that, when executed by the processor, instructs the apparatus to output, for display on a computing device, m an interactive experience editing tool. The processor also instructs the apparatus to receive one or more inputs from an input device communicatively coupled to the processor. The one or more inputs select one or more features of the editing tool, wherein the one or more features edit content for presentation to a participant during an interactive experience.

In another embodiment, a machine readable storage medium is provided for storing a first computer-executable code that, when executed by a processor, instructs an apparatus to present as a computer image renderable on a display device, a content selection pane. The code also instructs the apparatus to present on the display device, an editing canvas and further provides that upon a selection and dragging of a first content segment and at least one second content segment, wherein each of the first content segment and the at least one second content segment are identified on and selected from the content selection pane, and the selected segments are dragged onto the editing canvas, a plot structure diagram for an interactive experience is generated.

In another embodiment, a computer implemented method for creating an interactive experience is provided and includes the operations of populating, using a computer based tool, a plot for an interactive experience onto a digital canvas, wherein the digital canvas is generated by the editing tool and the plot includes at least one first node and at least one second node. The operations performed using the computer based tool may also include identifying a first content segment and a second content segment, populating the first node with the first content segment; populating the second node with the second content segment; and establishing a linkage between the first node and the second node.

In another embodiment, a computer-implemented method for an interactive experience is provided and may include the operations providing, to a computing device, at least one content segment, wherein the content segment relates to a storyline branch for an interactive experience. Additional operations may include receiving an input from the participant selecting a storyline branch and providing to the participant the content segments that correspond to the selected storyline branch.

In another embodiment, a computer implemented method for analyzing a progression by one or more participants through an interactive experience is provided. This embodiment may include the operations of presenting, on a computer display device, a plot structure diagram for an interactive experience. Additionally, the operations may include presenting, with respect to the plot structure diagram, a first progression through the interactive experience for a first participant selected from a group of two or more participants; and based upon the first progressions, associating a first user profile with the first participant.

In another embodiment, an apparatus for analyzing an interactive experience through which a participant progressed may be provided. Such an apparatus may include a local processor and a network interface in communication with the local processor. The network interface may be configured to establish a communications link with a remote processor hosting an interactive experience analytics tool residing as an application program on a machine readable storage medium accessible to the remote processor. When the communications link is established between the local processor and the remote processor, this embodiment may provide remote access to the interactive experience analytics tool such that a progression by the participant through the interactive experience can be analyzed by a user of the apparatus.

Other embodiments of the inventive concepts are discussed herein wither respect to the drawing figures and/or the detailed description provided below.

### BRIEF DESCRIPTION OF THE DRAWINGS

FIG. 1 is a flowchart illustrating accessing a website hosting an interactive experience which includes one or more video components.

FIG. 2 is a flowchart illustrating an embodiment of an interactive experience wherein one or more participants may select storyline branches during the presentation of one or more interactive experience related audio, video or data components.

FIG. 3 is a flowchart illustrating an embodiment of an interactive experience wherein either of two storyline branches may be pursued, with each branch including one or more video components provided as a multimedia presentation to one or more participants.

FIG. 4 is a flowchart illustrating an embodiment of an interactive experience providing video content to the one or more participants during an interstitial period between episodes of the interactive experience.

FIG. 5 is a flowchart illustrating an embodiment of an interactive experience providing two storyline branches following a bridge period, with each branch including video content provided as a multimedia presentation to one or more participants.

FIG. 6 is a flowchart illustrating an embodiment of an interactive experience of a concluding multimedia presentation episode for one or more participants.

FIG. 7 is a flowchart illustrating an embodiment of an interactive experience wherein one or more participants may select storyline branches during the interactive experience and some participants are restricted from accessing some aspects of the available interactive experience based on a status associated with a given participant.

FIG. 8 is a flowchart illustrating an embodiment of an interactive experience which includes two storyline branches, with each branch including interactive content provided as a multimedia presentation to one or more participants.

FIG. 9 is a flowchart illustrating an embodiment of an interactive experience providing content to the one or more participants during an interstitial period between episodes of the interactive experience.

FIG. 10 is a flowchart illustrating an embodiment of an interactive experience wherein a status of one or more participants is determined and based upon such status each of the one or more participants may be allowed or restricted from accessing some or all aspects of the interactive experience.

FIG. 11 is a flowchart illustrating an embodiment of an interactive experience providing for two or more storyline branches following a bridge period, wherein each branch may including interactive content provided as a multimedia presentation to one or more participants.

FIG. 12 is a flowchart illustrating an embodiment of an interactive experience which includes a concluding multimedia presentation for one or more participants.

FIG. 13 is a flowchart illustrating an interactive experience website providing an intellectual challenge to a participant as part of the interactive experience.

FIG. 14 is a flowchart illustrating an interactive experience website providing an embodiment of a dialogue branch to a participant as part of the interactive experience.

FIG. 15 is a flowchart illustrating an interactive experience website providing an embodiment of a dialogue branch to a participant.

FIG. 16 is a block diagram illustrating an exemplary computer system which may be used in implementing embodiments of the present disclosure.

FIG. 17 is a diagram of an exemplary webpage layout of a portion of an interactive experience providing entry into an interactive experience construction tool available to third party developers.

FIG. 18 is a diagram of an exemplary webpage layout of a portion of an interactive experience system providing an interactive experience construction tool available to third party developers.

FIG. 19 is a pictorial representation of an exemplary embodiment of a tool for creating an interactive experience in accordance with at least one embodiment discussed herein.

FIG. 20 is a representation of an exemplary embodiment of a project dashboard that may be used to create an interactive experience in accordance with at least one embodiment discussed herein.

FIG. 21A is a representation of an exemplary editing tool for use in editing an interactive experience in accordance with at least one embodiment discussed herein.

FIG. 21B is a representation of an exemplary content selection pane for use with the exemplary editing tool of FIG. 21A to edit an interactive experience in accordance with at least one embodiment discussed herein.

FIG. 21C is a representation of the content selection pane of FIG. 21B that has been populated with link to and/or content for multiple content pieces in accordance with at least one embodiment discussed herein.

FIG. 21D is a representation of an exemplary editing canvas for use with the exemplary editing tool of FIG. 21A to edit an interactive experience in accordance with at least one embodiment discussed herein.

FIG. 21E is a representation of an exemplary editor for use with the exemplary editing tool of FIG. 21A to edit an interactive experience in accordance with at least one embodiment discussed herein.

FIG. 21F is a second representation of the exemplary editor of FIG. 21E that has been populated with at least one tag in accordance with at least one embodiment discussed herein.

FIG. 21G is a third representation of the exemplary editor of FIG. 21E that has been populated with multiple tags in accordance with at least one embodiment discussed herein.

FIG. 22 is a representation of an exemplary analytics tool that may be used to analyze one or more user profiles and flows associated with one or more interactive experiences in accordance with at least one embodiment discussed herein.

FIGS. 23A and 23B are together a flow chart representing one embodiment of a process by which an interactive experience may be edited.

### DETAILED DESCRIPTION

One implementation of the present disclosure may take the form of a method and/or system for providing an interactive experience over a network that includes one or more non-interactive and/or interactive audio, video and/or data components, features, applications and/or functions (hereafter, collectively “content”). In one embodiment, the network may be the Internet and the interactive experience may be accessed by one or more users, singularly or collectively, through one or more websites. In certain embodiments, participants may include autonomous and/or semi-autonomous artificial intelligence users, commonly referred to as bots and automatons. Such users, whether human or otherwise, are herein referred to as “participants” but may are also commonly referred to as viewers, gamers, users, audience members, and other descriptors used to associate one or more persons being presented and/or interacting with content. The one or more websites may include a plurality of interactive features to entice and entertain participants in the interactive experience, for example, an interactive game. Such features may include, but are not limited to, intellectual challenges, such as puzzles, quizzes, tests and mindbenders; participatory challenges, such as games, videos and rewards; content related features, such as links to related content, pop-up videos, related audio tracks, graphics, three dimensional (3D) simulations, virtual experiences; and other forms of interactive content. Any form of content may be presented to the participants, for their active or non-active interaction, in accordance with any of the various embodiments discussed herein. The interactive experience may include one or more forms of a/v/d being presented to the participants through which a story including several scenes may be presented. The content may be interactive, as well, such that the participants may interact with the content to select storylines to follow, as if the participants are a part of the story presented. During breaks in the storylines, the interactive experience may also include additional interactivity, such as online forums to discuss the presentation, emails, text messaging or other communications between the participants or others, such as a participant's friends. Scavenger hunts, hints to aid in solving clues, and other forms of content may be presented.

As used herein, a “storyline” is any sequence of content that a participant may experience during one or more interactive experience sessions. A storyline may be pre-determined, controlled dynamic or fully dynamic. When pre-determined, the storyline may be fixed and participant interactivity may be limited to ancillary content, features and/or function relating to a given interactive experience. When controlled dynamic, a storyline may be configured to allow a participant to progress, during an interactive session, along one of many pre-determined and/or predictable paths to a desired given set of results. When fully dynamic, a storyline may enable a participant to progress along any path to any lawful end result; such a progression may involve the interaction of multiple storylines and/or interactive experiences. Thus, it is to be appreciated that the discussion herein of the various embodiments relating to one or more storylines are exemplary only and any such embodiment may be suitably modified, as the case may be, to facilitate interactive experiences with pre-determined, controlled dynamic and/or fully dynamic storylines or segments thereof.

The various embodiments discussed herein may provide several modes of interactivity. For example, in one mode, a participant may have a virtual role of being an investor or subscriber to one or more of the websites associated with a given interactive experience. Such role may also be actual, in that the participant may actually be an investor with respect to a company through which the interactive experience may be provided. As an actual or virtual investor, as provided for any given implementation of an embodiment discussed herein, the participant may not only share in any profitability of the company providing a given interactive experience, but may have access to certain aspects of the interactive experience and related websites that a non-investor cannot access. Similarly, a participant may be a non-investor subscriber that provides some form of consideration (e.g., money or bugs reporting) in order to receive access to features and functions provided by a given interactive experience that a non-subscribing participant does not receive. For example, a participant may provide actual or virtual money to the website to become a subscribing participant, such as by providing a credit card number or an identification of an online payment account. In another example, the participant may exchange points obtained during use of the interactive experience, or other interactive experiences, to achieve subscriber status. As used herein, online payments and points may both be considered “currency” associated with the interactive experience. In general, the host website may accept any type of currency in exchange for providing the user with subscriber status. An interactive experience may provide for different levels of subscriber activity, depending on advancement in the interactive experience or payment for additional access. Participating as a subscriber may provide several additional aspects to the interactive experience, including, but not limited to, additional intellectual challenges, rewards opportunities, access to restricted storylines and content, access to content editing software and additional interactivity with an interactive experience. Similarly, additional and/or other participant roles may be designated in various embodiments, such as an editor, publisher, or other role with respect to some or all of the content involved with the interactive experience. As used herein, such roles, with respect to any given functionality or element of an interactive experience are commonly referred to as “subscribers” and “non-subscribers” with “subscribers” having sufficient permission(s) to access, utilize, receive or otherwise interact with a given functionality or element of an interactive experience and “non-subscribers” not having sufficient permission(s).

Another mode of interactivity may include participating as a group or team in addition to participating as an individual. For example, an interactive experience wherein a group of people are collectively raising money for a charitable cause may result in additional content becoming available to the group participants as particular thresholds are reached.

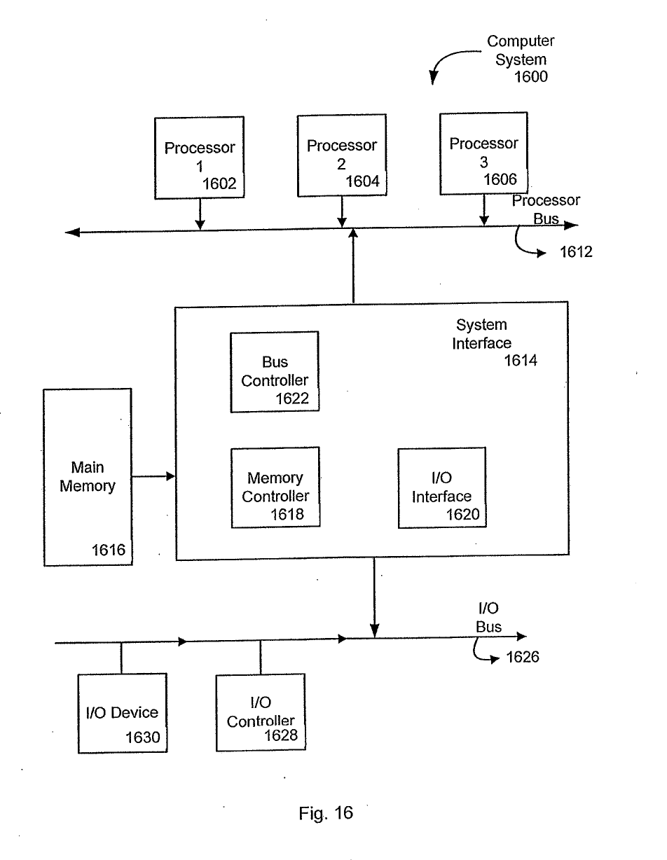

As mentioned, the interactive experience may be provided to one or more participants, over one or more networks of computing devices. In one particular embodiment, the network may be the Internet such that the participants engage in the interactive experience by accessing one or more websites by utilizing a computing device. However, other types of networks and communications connections may be utilized in addition or exception to the Internet including local area networks, peer-to-point connections, serial participation or “turn-based” participation and other forms of connectivity between two or more participants utilizing one or more computing devices. While the embodiments described herein discuss the Internet, it should be appreciated that one or more aspects of an interactive experience, such as a game, may be provided locally and/or over any network through any number of computing devices. Any form of computing device may be utilized by a participant to access an interactive experience providing content compatible with such computing device. Exemplary computing devices are discussed in more detail below with respect to FIG. 16 and include, but are not limited to, one or more set-top boxes related to a television distribution system, such as a satellite television system or cable television system, computer systems, mobile computing systems, such as smart phones and tablet computers and any other content compatible devices. One or more computer-readable medium, such as a CD-ROM, hard drive, thumb drive and other form of persistent or non-persistent storage and/or memory devices may be utilized to facilitate any given interactive experience. Such computer readable medium may facilitate an interactive experience, for example, by providing storage for the content and/or the software instructions needed to access, present and/or generate results from any given interactive experience. Such computer readable mediums may be local and/or remote to any given device utilized to present, store, record, experience or otherwise interact with an interactive experience.

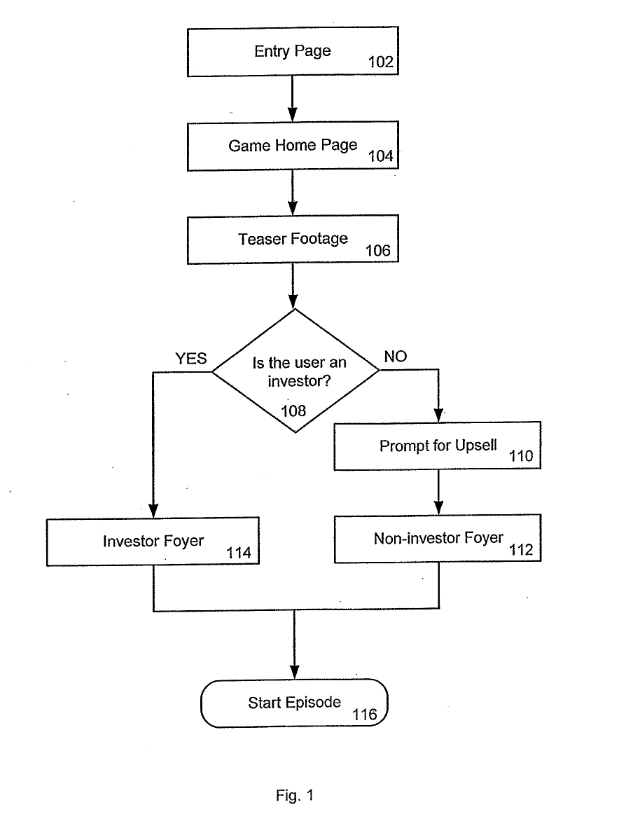

To access an interactive experience, such as an interactive game, a participant may, in at least one embodiment, first access a website or an application program associated with the interactive experience. In one embodiment, the participant may access an entry page to the interactive experience, as shown in operation 102 of FIG. 1. The entry page may be a website of a popular social networking site, a search engine-type website or any other website that may link to the interactive experience. In one example, the entry page may link to a website that hosts an interactive game, as shown in operation 104. In another example, the entry page may be a link to a download an application program to a mobile device, such as a smart phone or tablet computer. In another embodiment, a participant may access the interactive experience home page directly upon logging onto the network, thereby bypassing operation 102. In another embodiment, a participant may access the interactive experience by “tuning” to a source of content, such as a channel on a cable or satellite television systems, a source for a streaming a/v/d feed or by otherwise directing the computing device to establish a communications connection with a source of the interactive experience.

Upon accessing the interactive experience home page, a participant may be presented with an introductory multimedia presentation about the interactive experience in operation 106. The multimedia presentation may take any form presentable on a computing device. For example, in an implementation where the interactive experience is a game, the introductory presentation may be a video outlining a game play storyline, a listing of the high scorers of the game, a puzzle that the participant must solve to unlock the website and other forms of interactivity. In general, the introductory presentation may be any form of content presented to a participant. Further, in some embodiments, operation 106 may be bypassed or not implemented such that the participant, upon accessing the interactive experience home page, may proceed directly to being presented with the content. Similarly, in at least one embodiment, a participant may proceed to an inquiry as to whether they are an actual or virtual subscriber in the interactive experience, as per operation 108.

At operation 108, the participant may be prompted as to whether they are or are not a subscriber, or otherwise have a status that designates the participant has having greater or lesser privileges than any other given participant not having that same status. As mentioned, the website may prompt the user for an input to determine if the user is a subscriber. This prompt may take several forms. For example, the participant may select a button on the website that indicates the participant's status. Upon selection, the website may verify the status of the participant indicated by the participant's input by comparing an identifying feature of the participant, such as an Internet protocol (IP) address associated with a computing device utilized by the participant, with a maintained list of investors. In at least one embodiment, the website may identify the participant as a subscriber by prompting the participant to input or otherwise provide a user name and password, which may then be compared to a maintained list of subscriber user names and passwords. In at least one embodiment, an authenticator key may be utilized to assess whether a given participant is a subscriber with respect to one or more features and/or functions of an interactive experience. Any form of authenticator key may be utilized and one in embodiment the authenticator key may be a number provided to the participant at regular intervals based on a known number-generating seed that may be compared to a secured database such that matching numbers may authenticate the identity of the participant providing the key. This key may be provided to the interactive experience automatically, semi-automatically or manually, with the key being provided to the participant through any methodology, device or system, such as through an Internet browser, smart phone application, key chain token device, or other computing device utilized by the participant. In this manner, a computing device may provide an authenticator key to a participant that may be used to identify the status of the participant to the interactive experience, such as a multimedia interactive game, a multimedia advertisement or other form or rich content. In general, any method known or hereafter developed to identify a participant with a website or other source or provider of an interactive experience may be utilized in the embodiments described herein.

If the participant is determined to not be a subscriber, with respect to some, many or all of the features and/or functions of any given interactive experience, the website or other provider of the interactive experience, may prompt the participant to upgrade to investor status in operation 110. For example, the website may direct the participant to another related website that asks the participant for payment information to upgrade the participant's status such that access to desired (and even non-desired) features and/or functions may be provided. In another embodiment, the website may provide a pop-up window on a display device used by the participant, an audible message or any other form of content notifying the participant of the upgrade option and seeking a response thereto. In some embodiments, the prompt for upgrade of operation 110 may be skipped or delayed until a later time during or after the completion of an interactive experience.

If it is determined that the participant is not a subscriber, then the website may direct the participant to a non-investor webpage, herein called a “foyer”, in operation 112. Alternatively and/or additionally, if the participant is determined to be a subscriber (or selects to upgrade in operation 110), then the website may direct the participant to a subscriber foyer in operation 114. In one embodiment, the subscriber foyer and non-subscriber may be separate web pages providing access to separate game content. In another embodiment, the subscriber and non-subscriber foyers may be the same webpage, with access to some content restricted to the non-subscriber. In at least one embodiment, subscribers to the website may be provided additional content, features and/or functions of an interactive experience that are not available to the non-subscriber.

In one embodiment, the subscriber webpage may provide access to an additional webpage, herein called the “subscriber office.” The subscriber office webpage may store information related to the particular subscriber and the subscriber's progress through the interactive experience. For example, in an interactive game implementation, the office may maintain the subscriber's/participant's point total for the game, any items collected during play of the game gathered clues, social network contacts and other game or interactivity related content. In another example for an interactive shopping implementation, the office may maintain the subscriber's/participants points total for shopping discounts, as may arise from a frequent shopper program, any items purchased during the session and/or past sessions, social network contacts, such as friends purchasing similar items and other shopping or interactivity related content. In general, the office may include any content that is particular to that subscriber for one or more interactive experiences. In addition, the subscriber office may be customizable by the participant during the duration of an interactive experience or through multiple iterations of one or more interactive experiences. Thus, some web pages, or “rooms”, within the subscriber office may only become available to the participant upon completion or playing of certain precursor activities, such as the completion of an episode of an interactive game, or upon reaching particular milestones within an interactive experience. In general, the subscriber office may be designed to keep the attention of the subscriber participant during a participant's interactions with one or more episodes of an interactive experience.

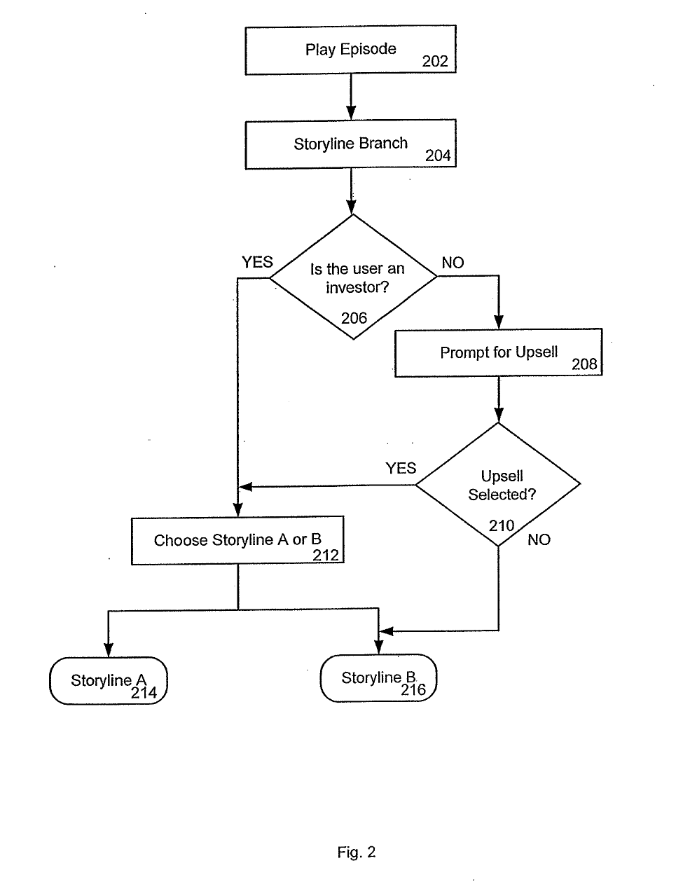

From either the subscriber foyer or the non-subscriber foyer, a participant may access the interactive experience in operation 116. In general, the beginning of the interactive experience is illustrated in the flowchart of FIG. 2. Initially, the interactive experience may begin by presenting content to the participant utilizing a suitable presentation device in operation 202. The content may be presented in several ways to the participant. For example, the website may embed the video within a website such that the participant is directed to the video upon selection to play the game. In another example, the video may be presented to the participant through a pop-up window. In still another example, the host website may link to another website affiliated with the host website that may display the video component.

At some point, the video may cease playing at a point where the storyline may branch, such as in operation 204. A storyline branch may be a point in the story where an input from a participant may be received to direct the flow of the story in a plurality of paths. For example, the video may proceed to a point where an input on which door to open may be prompted for from the participant. In general, the story presented by the video may halt at the storyline branch until an input is received by the participant, or until the website determines that the story is to continue.

The storyline presented by the content may halt at a branch in several ways. In one example, the content itself may stop and the participant may be directly linked to another website associated with the interactive experience. In another example, the content may continue playing, while the certain aspects are “frozen” or inactivated until any selection or a given selection, as the case may be, is made. For example, characters within a video may halt action until a trigger is activated. Similarly, the content may be presented in a looped fashion (e.g., playing the same video segment in a loop) such that the actors perform the same actions until a selection is made. In yet another example, the characters within the video may themselves prompt the participant for the input to select the next storyline.

In one embodiment (as shown in FIG. 2), the website may again determine if the participant is a subscriber in operation 206. If the website determines that the participant is not a subscriber, the website may then prompt the participant to upgrade to subscriber status in operation 208. If the participant upgrades in operation 210, then the website may direct the participant to select between a plurality of storylines to continue the interactive experience (such as in operation 212). However, if the participant is not a subscriber, the website may automatically select a storyline for the participant. In the example shown, the website may direct all non-subscribers to storyline B in operation 216. This is but one example of additional content that may be available to subscriber participants versus non-subscriber participants. More particularly, subscriber participants may select from two storylines in operation 212, namely between storyline A in operation 214 and storyline B in operation 216, while non-subscriber participants are directed to storyline B, thereby removing the option of selecting which storyline to follow.

In addition, the participant may select a storyline in operation 212 in several manners. For example, the website may provide a pop-up window prompting the participant to provide some input on which storyline is requested, such as by pressing a button or typing in a response. In another example, the participant may provide an input directly into the presented content, such as through a mouse-click on a particular area within a video, a verbal response, a shaking of a device, or other participant input, wherein the desired participant is pre-determined, or real-time determinable by the website. In general, any method by which a participant may provide an input to a source of an interactive experience, such as a website, may be utilized to receive the selection of the storyline in operation 212.

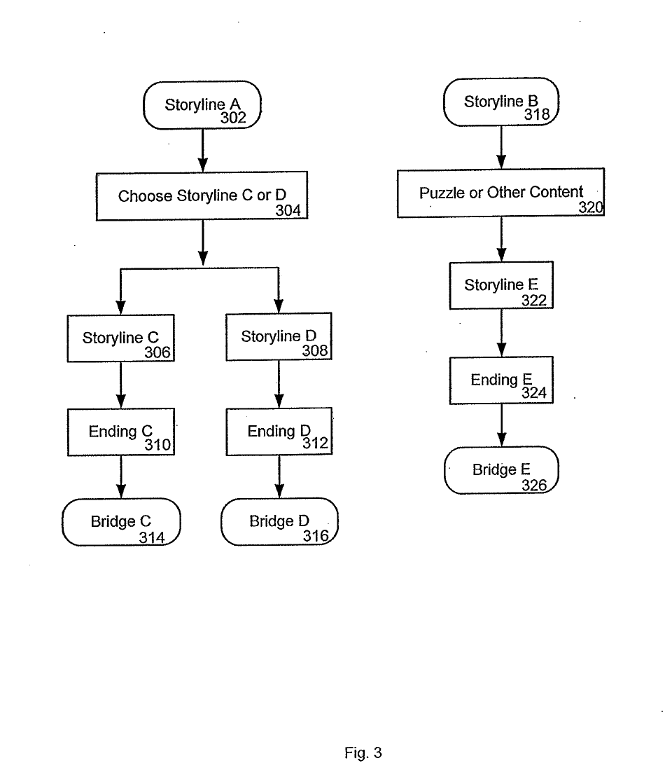

Upon selection of storyline A or storyline B, additional a/v/d content may be provided to or accessible by a participant, as shown in FIG. 3. For example, storyline A may include an additional video component (in operation 302) that displays the consequences of the participant's choice of storyline. For example, the participant may choose to open a first door displayed in the video, thereby selecting storyline A in operation 212, and the contents of the room behind the door may be shown in the video displayed in operation 302. In one exemplary implementation, the door could be a car door which upon being opened the interactive experience presents to the participant a virtual driving experience. In another exemplary implementation, the door could be presented in the context of a game, whereupon being opened a secret chamber is presented. In addition, the video of storyline A may continue in a similar manner until a second storyline branch is reached in operation 304, at which point the website may receive another input from the participant selecting between storyline C and storyline D.

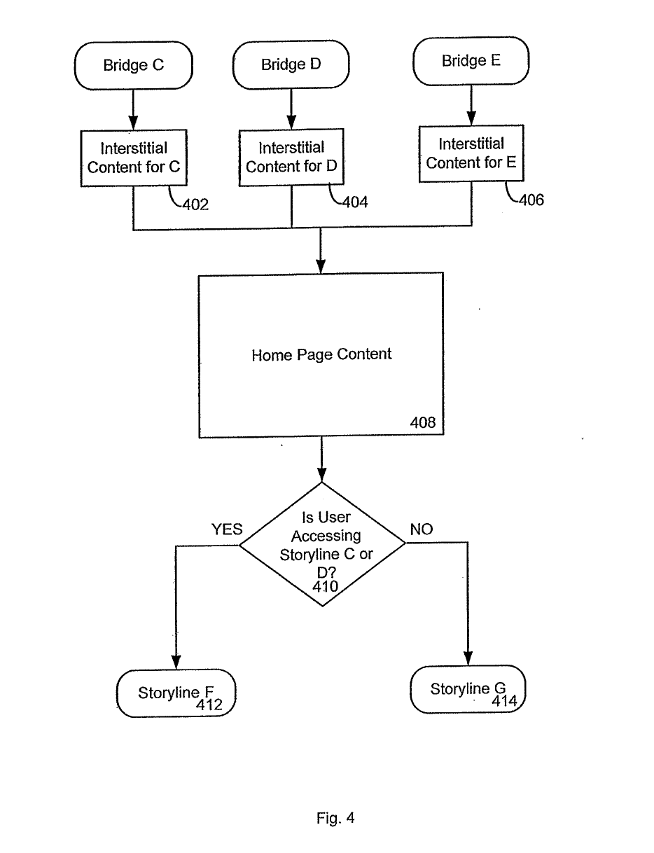

If storyline C is selected in operation 304, then a storyline C video may be presented in operation 306 until such video ends in operation 310. Similarly, if storyline D is selected in operation 304, then a storyline D video may be presented in operation 308 until such video ends in operation 312. Upon completion, the website may proceed to a bridge for storyline C (operation 314) or a bridge for storyline D (operation 316). The bridge operations are discussed in greater detail below with reference to FIG. 4.

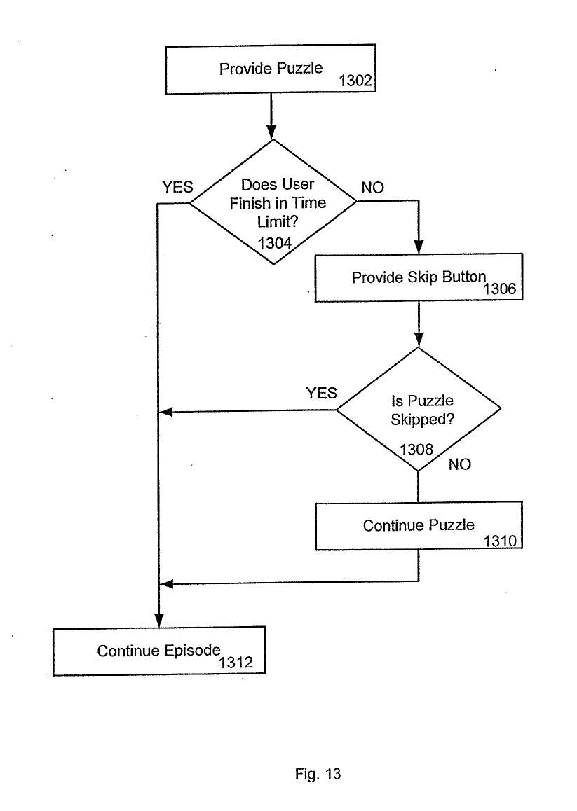

Storyline B may also include an a/v/d component displayed to the participant in operation 318. Upon completion of the content for storyline B, the website may then provide a puzzle or other content to the participant in operation 320. For example, the storyline B video may end by showing a door that may be unlocked by solving a puzzle. Thus, the website may then provide the puzzle to the participant to solve before the story may proceed. In general, however, a puzzle or any other content described herein may be presented to the participant at any point. For example, storyline A, storyline C or storyline D may also include a puzzle or other content. The inclusion of the puzzle in storyline B is merely an example of the variety of multimedia content that may be provided to the participant by the website during play of the game. Further, the puzzles may be provided dependent on the status of the participant. For example, the puzzle or additional content may only be provided to subscriber participants that have selected the appropriate storyline. Therefore, in the embodiment shown, a non-subscriber participant may be skipped over operation 320 and directed to operation 322 upon completion of storyline B. Aspects of the puzzle and other interactive experience content are discussed in greater detail below with reference to FIGS. 13 through 15.

Upon completion of the puzzle by the participant, or upon completion of a time-out function of the interactive experience, such time-out being determined, for example, by the website hosting the interactive experience, the interactive experience may continue to operation 322 and present storyline E to the participant until the such video ends in operation 324. Once the video for storyline E ends, the website may then proceed to a bridge for storyline E in operation 326.

In general, the bridge for any storyline may constitute the time between releases of the interactive content, for example, a video, to the game source of the interactive experience, for example, a gaming website. In one embodiment, episodes of the story may be provided to the participants through the website at a rate of one per week. This may allow time for the production of the content associated with a given interactive experience, as well as time to develop the other various related content provided through the website.

To maintain interest in the interactive experience between bridges of the storyline, the source or website may provide several aspects of content to the participants. For example, in FIG. 4, interstitial content for each of the storylines may be provided by the website to one or more participants of the interactive experience. More particularly, the website may provide interstitial content for storyline C in operation 402 to those participants who have selected that storyline path, interstitial content for storyline D in operation 404 to those participants who have selected storyline D and interstitial content for storyline E in operation 406 to those participants who have selected that storyline. In general, interstitial content may be provided to any participant associated with any storyline that ends in a bridge. Further, such content may vary depending on the level of the participant, such that subscriber-type participants may receive more or different types of content than non-subscriber participants.

The interstitial content may include any multimedia content that relates to the interactive experience. In one example, the interstitial content may include an email that is sent to the participants that furthers the interactive experience, such as by providing instructions to the participant on where to access additional content or providing a puzzle to the participant that must be solved to continue the interactive experience. In another example, the interstitial information may be recap of the interactive experience up to a given bridge point. This content may be provided directly to the participant through any form of communication, including but not limited to email, phone, letter, text message, postings and other forms of single cast (e.g., person-to-person), simulcast (e.g., a posting only to FACEBOOK “friends”), and/or multi-cast (e.g., a blog posting) communications. Additionally, the content may be available through the host of the interactive experience, such as a gaming host website, in either the subscriber form or non-subscriber foyers.

During the bridge period, additional game content may also be accessed through the home website for the interactive experience, in operation 408. In general, the home website may provide more content for the interactive experience, as well as forums to discuss the interactive experience, additional puzzles, research tools, clues to processing through the interactive experience and other interactive experience related information. Further, as discussed above, this content may be restricted to certain participant status, such as subscriber and non-subscriber content. Such additional content may also be storyline specific such that some content may only be available to those participants that have played a storyline related to the content. In general, the home webpage content available in operation 408 may be configured to retain a participant's interest in the interactive experience during any bridge periods.

At some point after the bridge period, additional episodes of the interactive experience may be released through the source (e.g., a gaming home webpage). Such episodes may include any desired form of content. In the embodiment of FIG. 4, storyline C and storyline D may be merged at the bridge point. Thus, the source/website may determine, in operation 410, whether a particular participant is accessing storylines that are merged. If so, then the participant may be directed to storyline F in operation 412. Alternatively, the source/website may direct certain participants to storyline G in operation 414.

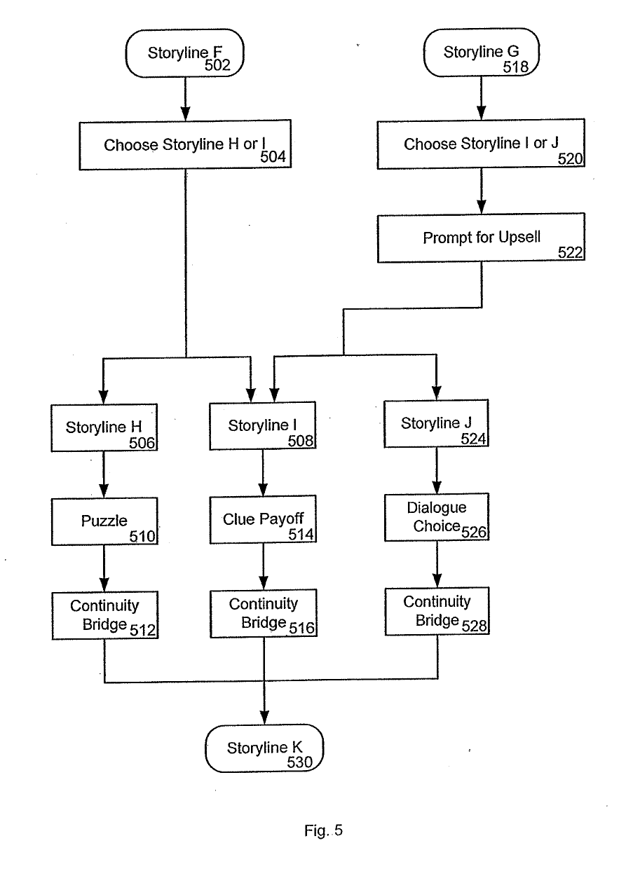

The post-bridge period interactive experience may have a similar structure as described above. An example of the post-bridge period of the game play, in the context of an interactive gaming experience, is shown in FIG. 5. In the example shown, the website may provide a video that demonstrates storyline F in operation 502 that ends at a storyline branch in operation 504. An input may be received by the participant to select between storyline H 506 and storyline I 508. Storyline H may proceed to the presentation of a puzzle in operation 510 and then to a continuity bridge 512 that merges storyline H with a common storyline, such as storyline K. Similarly, the website may provide a video that demonstrates storyline I in operation 508 to those participants that select storyline I. The website may then proceed to the presentation of a clue payoff content in operation 514. The clue payoff content is explained in greater detail below. After providing the clue payoff, the website may then continue to a continuity bridge 516 that merges storyline I with a common storyline. The content of these flowcharts may be provided to the participant in a similar manner as described above.

Returning to FIG. 4, if it is determined in operation 410 that the participant is not accessing storyline C or D, then the website may direct the participant to storyline G in operation 414. Continuing on to FIG. 5, the website may provide a video that demonstrates storyline G in operation 518 that ends at a storyline branch in operation 520. Also, similar to the storyline branch in FIG. 2, the website may again prompt the participant to upgrade the participant's status in operation 522. In general, however, the prompt for upgrading the participant's status may appear at any point or points, and with any desired frequency, within the interactive experience. It is used here as merely an example of possible locations for prompting the participant to upgrade the participant's status.

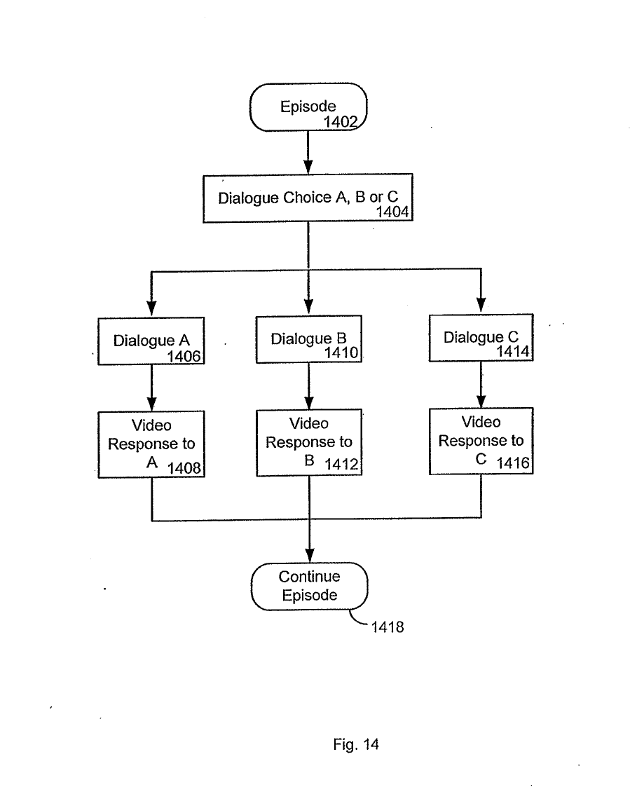

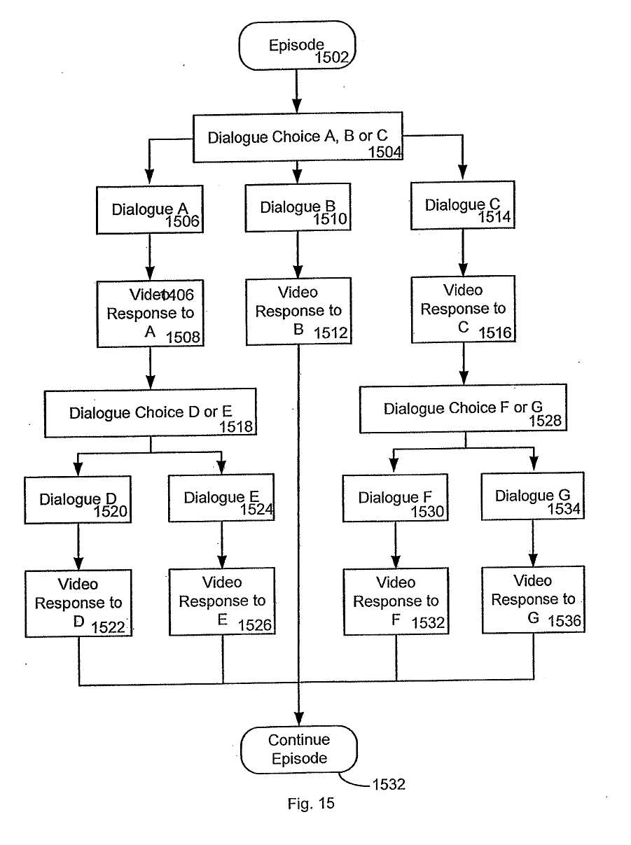

An input may be received in operation 520 or 522 by the participant to select between storyline I 508 and storyline J 524. The progression of storyline I is discussed above. In a similar manner, storyline J may proceed to the presentation of a dialogue choice puzzle in operation 526 and then to a continuity bridge 528 that merges storyline J with the common storyline. The dialogue choice puzzle of operation 526 is described in more detail below with reference to FIGS. 14 and 15.

As shown, each storyline may be merged into a single storyline in operation 530, regardless of the storyline paths chosen above. However, this is but one example of how an interactive experience may be structured. It should be appreciated that any number of storylines may be created and merged during an interactive experience as desired by the designers thereof or as dynamically determined based upon participants interactions therewith.

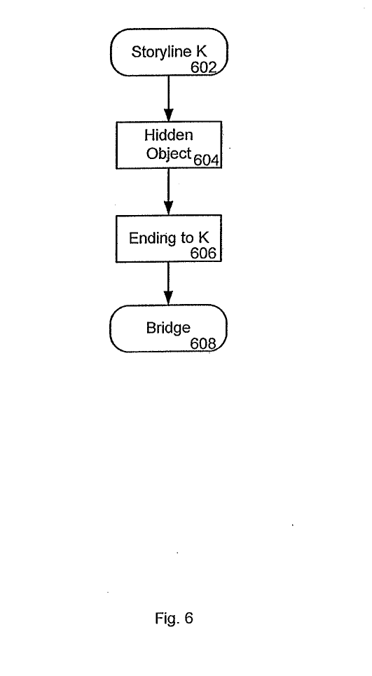

Storyline K may continue in operation 602 of FIG. 6. Similar to the above storylines, the website may provide a video that demonstrates storyline K in operation 602. The website may then proceed to the presentation of a puzzle, such as a hidden object puzzle, in operation 604. After providing the puzzle and receiving a response, the website may then display an ending to the storyline K in operation 606 and continue to a bridge 608, similar to those bridges discussed above. In this manner, the website may provide several episodes, puzzles and other content of the interactive experience while providing enough time to produce any content to be utilized later during or with one or more interactive experiences.

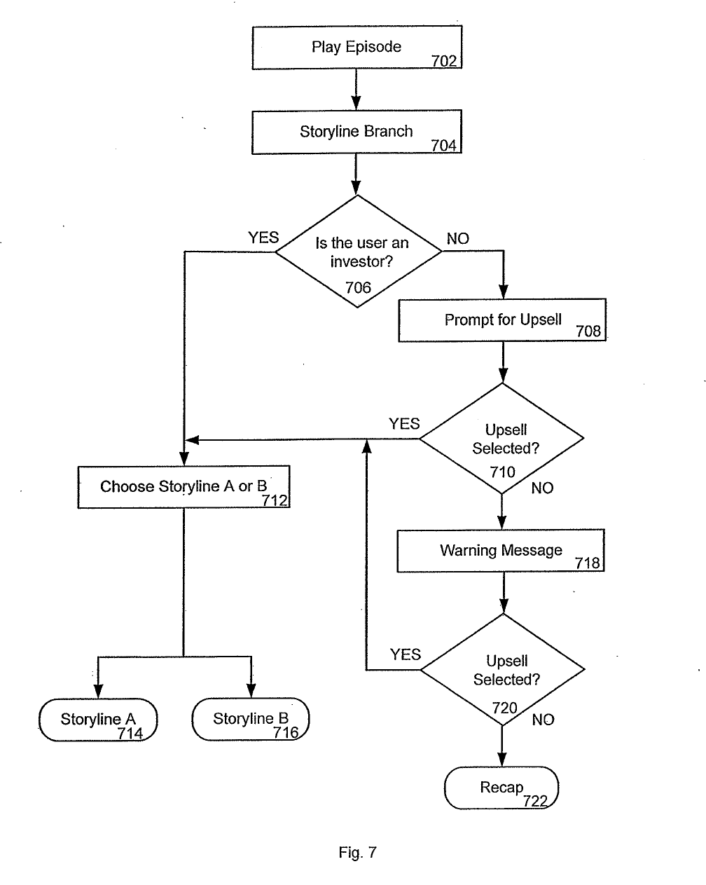

FIGS. 7 through 12 include another embodiment of the interactive experience presented through a source, such as a game host webpage. Although similar to the previous example discussed in FIGS. 2 through 11 above, this embodiment illustrates one example of altering the content available to a participant based on the participant's status. In general, the embodiment of FIGS. 7 through 12 provide non-inventors with less access to content, features and/or functions of an interactive experience than is provided to subscribers.

As mentioned, the operations of the embodiment of FIGS. 7 through 12 may be similar to those operations discussed above. Thus, operations 702 through 716 of FIG. 7 may be the same as those corresponding operations of FIG. 2 and discussed above. In summary, the website may provide content that includes a storyline branch. A subscriber may select between storyline A or storyline B to continue. A non-subscriber is prompted to upgrade to subscriber status, similar to the embodiment described above. However, in the embodiment of FIG. 7, the penalty for not upgrading to subscriber status may be more severe than in previous embodiments.

More particularly, the website may determine if the participant has agreed to upgrade to the subscriber status in operation 710. If the website determines that the participant has declined the upgrade offer, the website may then provide a warning message to the participant in operation 718. The warning message may inform the participant that further video content or other game content may be available only to subscribers. The warning message may appear to the participant in several manners. For example, a pop-up window may appear on the participant's display device that includes the warning message. In another example, the website may direct the participant to a secondary website that includes the warning message. In yet another example, the warning message may be provided to the participant through a secondary communication device, such as over email, a text message, a phone call, or by any other desired form of communication. In general, the warning message may be provided to the participant in operation 718 in any manner known or hereafter developed.

Upon providing the warning message, the website may again query the participant for an upgrade to subscriber status in operation 720. In at least one embodiment, this query may be similar to the first prompt asking the participant to upgrade. In other embodiments, this query may be different to the first prompt and may provide additional reasons for why a given participant should consider upgrading to subscriber status, for example, an indication of savings the participant would have realized had they already upgraded to subscriber status. If the website determines in operation 720 that the participant has agreed to achieve subscriber status, the website may direct the participant to operation 712 where the subscriber participant may select between storyline A and storyline B. However, if the website determines that the participant has declined the upgrade and remains a non-subscriber, the website may then direct the participant to a recap in operation 722.

In general, the recap of operation 722 may provide a summary of the storyline or content of one or more interactive experiences that may be presented to subscriber participants but are not available to non-subscriber participants. More particularly, the recap may summarize one of the storylines available and direct that participant to the summarized storyline only. Thus, non-subscribers may not have access to selecting between storylines, thereby rendering inaccessible some interactive content, features and/or functions to non-subscriber participants. Further, the recap may be provided to the non-subscriber participant in any manner described above, including a pop-up window, text message, through the game home website and by other manners of a/v/d notifications.

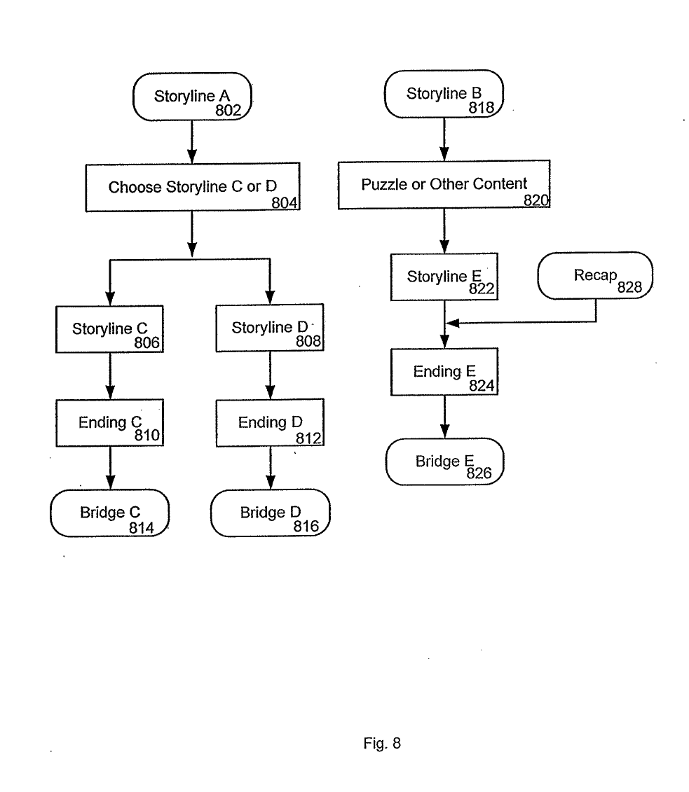

In addition, the non-subscriber participant may be directed to a particular storyline that is next presented during an interactive experience. For example, as shown in FIG. 8, the recap 828 may summarize the plot for storyline B and storyline E and direct the participant to the end of storyline E such that the non-subscriber participant may be aware of the story progression without being able to view the related content, access any storyline E features or functions or otherwise participate in the selection of storylines and/or subsequent interactive experiences provided by a given source, such as a gaming host website. The puzzles and other content provided to subscriber participants during a given interactive experience, and/or during subsequent interactive experiences, may also be restricted from the non-subscriber participants. In this manner, much of the content is removed from access by the non-subscriber participants, yet the non-subscriber participants may still participate in the interactive experience, in a more limited manner, through the recaps.

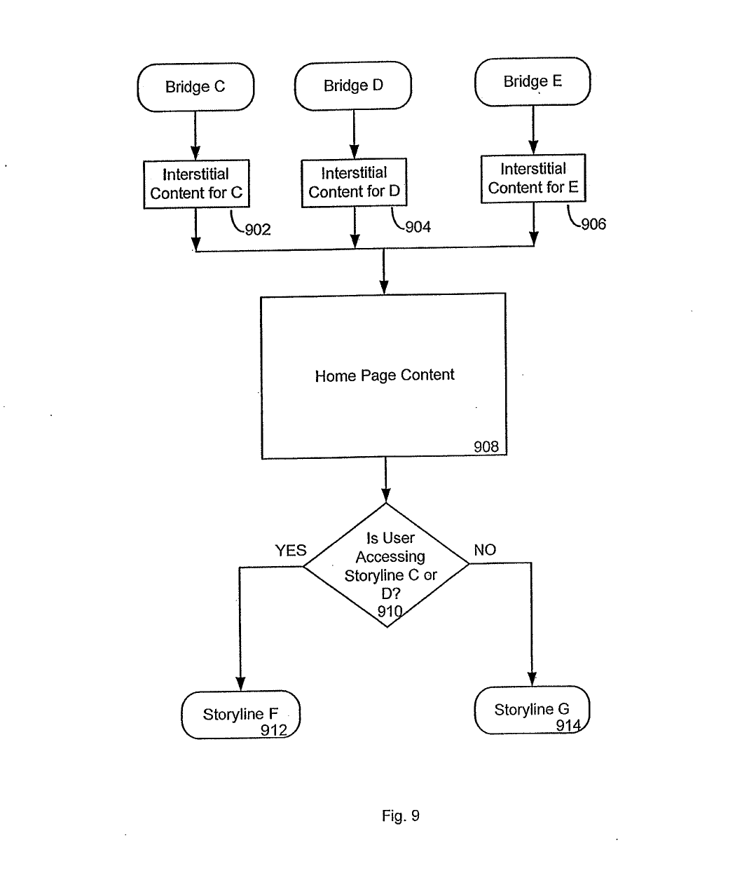

For subscriber participants, the source or gaming host website may operate in a similar manner as described above. Thus, as subscriber participants select certain storylines to follow, videos and other content may be provided to the subscriber participants. Further, the storylines may proceed to a bridge point, as discussed. As shown in FIG. 9, the website may provide interstitial information to subscriber and non-subscriber participants. Further, the content may be available on the game home page during the bridge period, as discussed above.

At some point after the bridge period, additional episodes of content for a given interactive experience may be released through the source, e.g., a game host webpage. For example, in the embodiment of FIG. 9, storyline C and storyline D may be merged at the bridge point. Thus, the website may determine, in operation 910, whether a particular participant is accessing those storylines that are merged. If so, then the website may direct those participants to storyline F in operation 912. Alternatively, the website may direct those participants to storyline G in operation 914.

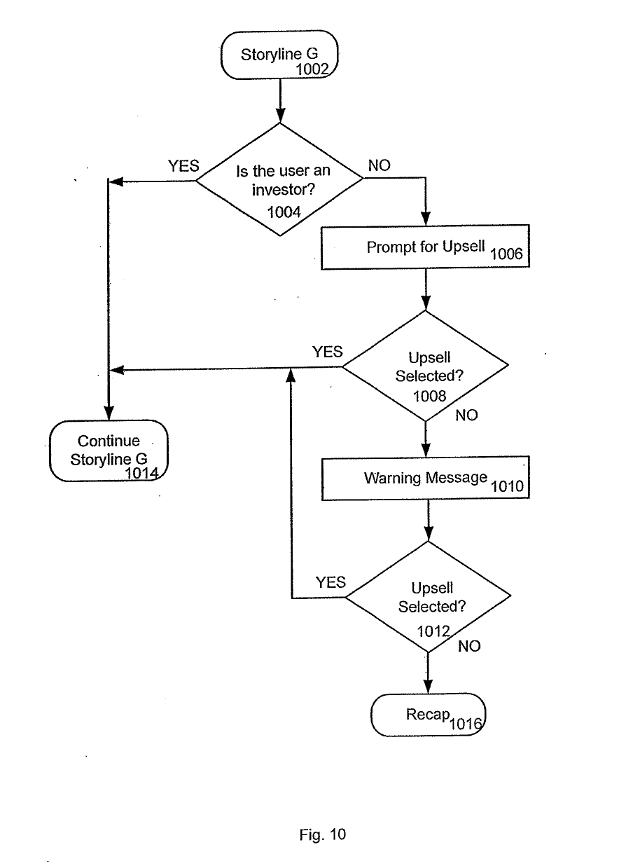

It should be noted that, because non-subscribers are relegated to storyline E in the embodiment shown, all non-subscriber participants may similarly be relegated to storyline G based on the determination made by the website in operation 910. Thus, in FIG. 10, the website may again query the non-subscriber participant to determine if the non-subscriber participant wishes to upgrade to subscriber status in operations 1004 and 1006. Further, the website may again determine if an upgrade is selected by the participant in operation 1008, provide a warning to the non-subscriber participant about lost or otherwise unavailable content, feature and/or functions in operation 1012 and ultimately direct the non-subscriber participant to a recap in operation 1016, rather than provide subscriber content, features and/or functions to the non-subscriber participants. The recap may include the same features as described above with relation to the recap of FIGS. 7 and 8.

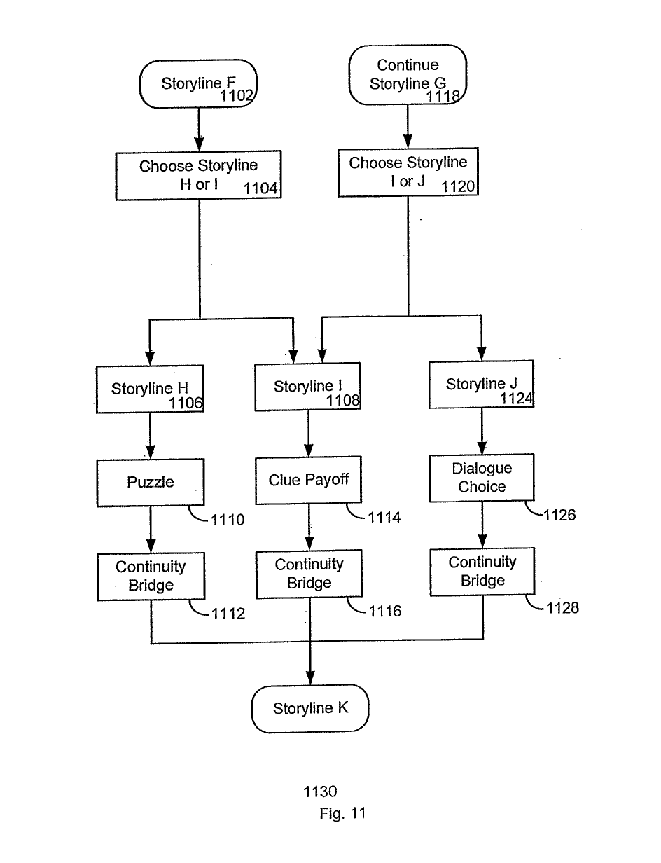

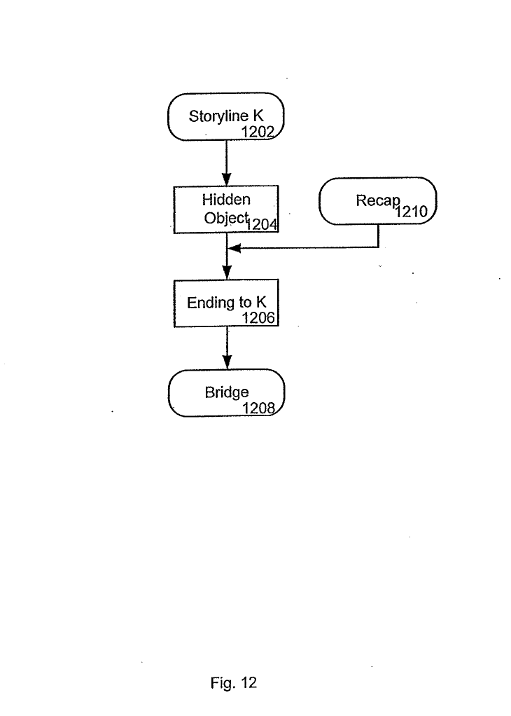

For subscriber participants, the interactive experience may continue as described above. Thus, the operations shown in FIG. 11 may be the same operations as described above with relation to FIG. 5. Similarly, the operations of FIG. 12 may also be the same as those corresponding operations of FIG. 6. However, in this embodiment (and shown in FIG. 12), the website may direct non-subscriber participants to the end of storyline K, such that non-subscriber participants are restricted from accessing the content provided in FIGS. 11 and 12. In this manner, the website may entice participants to upgrade to subscriber status to access content, features and/or functions that are not provided to or accessible by non-subscriber participants.

As illustrated above, the interactive experience may include additional content, features and/or functions, other than video clips, to provide an entertaining, informative, productive or otherwise desired experience for the participant. One such additional content may be a puzzle that is presented to the participant during an interactive experience that may be solved prior to continuing the experience. One example of providing a puzzle to a participant is shown in FIG. 13. The flowchart of FIG. 13 is but one example of a method for providing a puzzle to one or more participants of an interactive experience, such as an online interactive gaming experience.

Beginning in operation 1302, the website may provide the puzzle to one or more participants of the game. The puzzle may be provided within a website associated with the game, may be provided in one or more pop-up windows, may be provided through a secondary communication, may be provided within the video of the interactive game or may otherwise be provided, using any desired form of communication, to one or more participants of the game. In general, the puzzle may be any multimedia interaction provided to a participant of the game through a computing device.

Upon providing the puzzle, the website may begin a timer configured to end when the participant completes the puzzle. After a set time, the website may determine if the participant has solved the puzzle in operation 1304. In general, the website may assign any amount of time as the time limit. In one example, the puzzle may be available for one minute. If the website determines in operation 1304 that the puzzle has not been solved, then the website may provide a button to the participant to skip the puzzle and continue on with the gameplay in operation 1306. Thus, in operation 1308, the website may determine if an input has been received indicating that the participant desires to skip the puzzle. If such an input is received, the website may direct the participant to the next section of the video in operation 1312. However, if the participant does not wish to skip the puzzle, the website may continue the puzzle in operation 1310 before directing the participant to the next section of the video. Additionally, the video components of the interactive game may interact with the participant's choices concerning the puzzle. For example, upon solving the puzzle, the characters within the video component may provide accolades to the participant through a dialogue displayed within the video.

In addition to providing video clips that outline the story, the website may also provide branches within the dialogue of the videos to further provide configurability to the story by the participants. For example, FIG. 14 illustrates one example of a dialogue selection tree that may be included in an interactive experience, such as an interactive game. Similar to the storyline branches described above, the interactive experience may include a portion where a participant selects from a plurality of dialogues in response to the video. Thus, in operation 1404, the participant may be presented with a choice between three dialogues related to the video component of the interactive experience. Upon selection, the website may present a video clip that corresponds to the participant's selection. For example, upon selection of dialogue A (operation 1406), the website may provide a video clip that responds to that dialogue selection in operation 1408. A similar feature may be available for dialogue choices B and C. Upon playing the video response, the website may direct the participant back to the episode in operation 1418.

FIG. 15 is another example of a dialogue selection tree for an interactive experience. Although similar to the dialogue tree shown in FIG. 14 and discussed above, the embodiment of FIG. 15 illustrates that subsequent dialogue choices may be provided to the participant after playing a video clip responding to a dialogue choice. In this manner, any number of dialogue branches may be provided within the interactive experience, with one or more dialogue choices being associated with a video clip.

Additional content may also be provided by the website during one or more interactive experiences. For example, as mentioned above, clues to aid in progressing through an interactive game may be provided to one or more participants during the bridge period between game episodes. These clues may be useful during gameplay, such as when a puzzle is encountered. Further, because some clues are only provided to subscriber participants, the clue payoff may provide an additional incentive to participants to upgrade their status to subscribers.

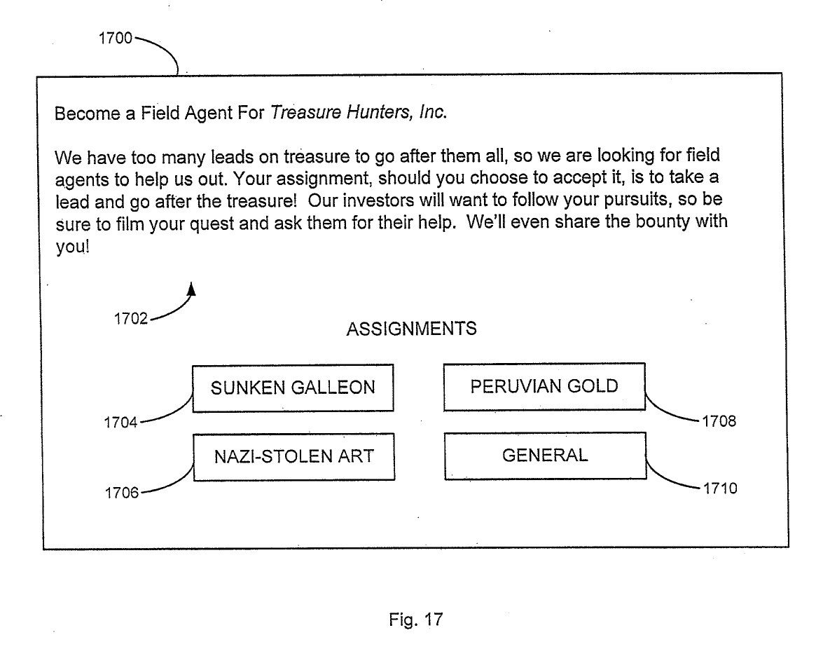

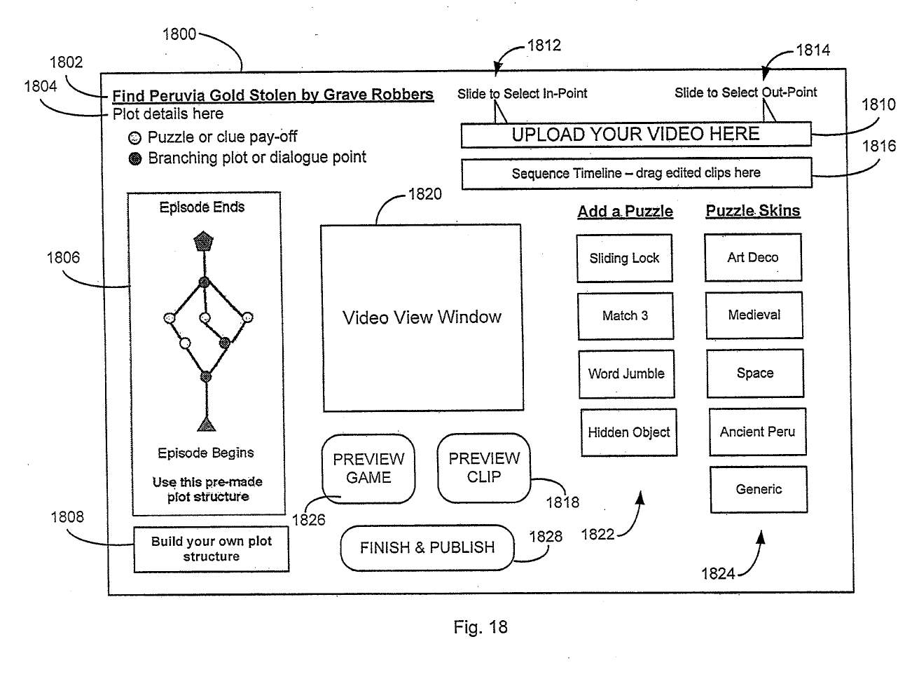

Other additional content, features and/or functions may also be provided, such as the ability to edit or create videos or dialogue trees related to the interactive experience. In one example, the website may provide editing tools to subscriber or non-subscriber participants. The website may also provide video and/or audio clips related to the gameplay that may be manipulated by the editing tools. For example, the website may incorporate a drag-and-drop feature that allows a participant to select a video scene or audio clip, drag the clip along the interface and drop the clip to create a video sequence. In addition, the editing tool may allow a participant to select portions of the video clips as part of the user-generated scene. Once each of the desired video clips or scenes are assembled, the editing tool may create a single scene from the selected clips that may then be available through the host or source of the interactive experience. In certain embodiments, the host may be the participant's computing device. In this manner, the website may provide the participants with tools to edit video and/or audio clips that may be integrated into the interactive experience, whether for the particular participant that creates the edited clips or for any participant of the interactive experience or subsequent interactive experiences, thereby allowing a participant to create one or more user-created interactive experiences containing any desired content. Aspects of these additional interactive experience creation, editing and/or production functionalities are described in more detail below with reference to FIGS. 17 and 18.

Further still, the interactive experience may provide for a multi-participant version, for example, a multi-participant online game. For such an implementation, the interactive experience may facilitate several participants interacting with the content (in this implementation, a/v/d gaming content) as a group. In general, the game play, storyline and/or interactive experience may be similar to that described above. However, in this example, storyline branches, puzzle solution, dialogue choices and the like may be decided by a group of participants. In one example, the gameplay decisions may be decided through a voting mechanism, such that the choice that receives the most votes from the group of participants is chosen. In this example, the host website may provide a voting mechanism within the website to receive the participant's votes and make the group decision. In another embodiment, the group of participant's may attempt to solve a puzzle within the game through a race feature, wherein the first participant within the group that solves the puzzle receives additional points or bonuses. The group play version of the interactive experience may include subscribers only or subscriber and non-subscriber's alike.

An additional feature of the group interactive experience may involve the team members communicating during the experience. For example, the team members may be connected to a chat feature offered through a source or game host website such that messages may be transmitted between participants. In another example, the team members may communicate through one or more voice communication devices. In other embodiments, video and other forms of communication may be supported. In general, any method by which the team members may communicate through the network may be integrated within an interactive experience and regardless of whether a given interactive experience involves solo or group interaction. Further still, the interactive experience may include one or more bonus episodes, content available to group members only. These episodes, content may be available to subscriber participants only that belong to a group and must be performed by the group. For example, in the case of an interactive shopping experience, group members might receive a larger discount if all the members purchased or otherwise acquire a given product or service. The bonus episodes, content may provide more interactivity with the participants, including additional bonuses, clues, points and entertainment for the group participants. Although providing additional entertainment to the group participants, the bonus episodes, content may end in a similar point in the story as the bridge such that those that have not played the bonus episodes will not be left behind in the progress of a given interactive experience.

Another puzzle that may be provided to the participant during an interactive experience may involve a hidden object game either integrated into one or more of the content components of the game or as a separate puzzle. In general, the hidden object game may include providing a scene or series of scenes to the participant and query the participant to locate one or more objects within the scene. To locate the objects, the participant may use an input device, such as a mouse or stylus, and indicate the object within the scene. Points or rewards may be provided to the participant upon finding the requested items.

In the embodiment where the hidden object game may be integrated into the one or more video components of an interactive game, the game may first instruct the participant to search for objects located within a video clip. At some point during the playing of the video clip, the object may appear within the video. The website may then create a hotspot within the video frame around the object that may receive an input from the participant. Thus, while the participant is viewing the video clip, the object may appear within the hotspot such that selection of the object by the participant with an input device may select, or “find”, the object. In this manner, the hidden object game may be integrated into the video clips associated with the interactive game.

FIG. 16 is a block diagram illustrating an example of a computer system 1600 which may be used one or more of the various embodiments discussed herein. The computer system 1600 disclosed may be utilized to provide the source of the interactive experience and/or may be utilized to access the interactive experience. Such computing devices include, but are not limited to, a network server, a router device, a desktop computer, handheld computing device, personal digital assistant, mobile telephone, music or audio participant (such as an MP3 participant) and any other device or combination of devices capable of providing, creating, accessing, presenting, utilizing or otherwise engaging in and/or with the content of any given interactive experience.

In at least one embodiment, the computer system (system) may include one or more processors 1602-1606. Processors 1602-1606 may include one or more internal levels of cache (not shown) and a bus controller or bus interface unit to direct interaction with the processor bus 1612. System interface 1614 may be connected to the processor bus 1612 to interface other components of the system 1600 with the processor bus 1612. For example, system interface 1614 may include a memory controller 1618 for interfacing a main memory 1616 with the processor bus 1612. The main memory 1616 typically includes one or more memory cards and a control circuit (not shown). System interface 1614 may also include an input/output (I/O) interface 1620 to interface one or more I/O bridges or I/O devices with the processor bus 1612. One or more I/O controllers and/or I/O devices may be connected with the I/O bus 1626, such as I/O controller 1628 and I/O device 1630, as illustrated.

I/O device 1630 may also include an input device (not shown), such as an alphanumeric input device, including alphanumeric and other keys for communicating information and/or command selections to the processors 1602-1606. Another type of user input device includes cursor control, such as a mouse, a trackball, or cursor direction keys for communicating direction information and command selections to the processors 1602-1606 and for controlling cursor movement on the display device. Still another type of input device includes a touch-screen device on the computing device that senses the placement of a user's finger or stylus to detect the location of the input on the screen of the device. Yet another input device may include a remote control utilizing infra-red (IR) technology, such as a remote control of a set-top box. In general, the computing system may include any type of device for providing input to the system known or hereafter developed.

System 1600 may include a dynamic storage device, referred to as main memory 1616, or a random access memory (RAM) or other devices coupled to the processor bus 1612 for storing information and instructions to be executed by the processors 1602-1606. Main memory 1616 also may be used for storing temporary variables or other intermediate information during execution of instructions by the processors 1602-1606. System 1600 may include a read only memory (ROM) and/or other static storage device coupled to the processor bus 1612 for storing static information and instructions for the processors 1602-1606. The system set forth in FIG. 16 is but one possible example of a computer system that may employ or be configured in accordance with aspects of the present disclosure. Other embodiments of computing devices and/or systems may be utilized including those that utilize web or cloud based storage, remote storage, thin client applications (where significant processing capability is shifted to a remote server) and other configurations of computing devices and/or systems.

According to one embodiment, the above techniques may be performed by computer system 1600 in response to processor 1604 executing one or more sequences of one or more instructions contained in main memory 1616 or elsewhere, for example, on the “cloud.” These instructions may be read into main memory 1616 from another machine-readable medium, such as a storage device. Execution of the sequences of instructions contained in main memory 1616 may cause processors 1602-1606 to perform the process steps described herein. In alternative embodiments, circuitry may be used in place of or in combination with the software instructions. Thus, embodiments of the present disclosure may include both hardware and software components.

A machine readable medium includes any mechanism for storing information in a form (e.g., software, processing application) readable by a machine (e.g., a computer). Such media may take the form of, but is not limited to, non-volatile media and volatile media. Non-volatile media includes optical or magnetic disks. Volatile media includes dynamic memory, such as main memory 1616. Common forms of machine-readable medium may include, but is not limited to, magnetic storage medium (e.g., floppy diskette); optical storage medium (e.g., CD-ROM); magneto-optical storage medium; read only memory (ROM); random access memory (RAM); erasable programmable memory (e.g., EPROM and EEPROM); flash memory; or other types of medium suitable for storing electronic instructions. As discussed above, memory components may be local or remote to a given computing device and may be connected to a computing device or system via one or more network connections.

As mentioned above, one aspect of the web-based interactive experience may provide one or more development, editing and production tools such that one or more users, participants and/or other third parties with respect to one or more interactive experiences may develop a unique experience, portions of an experience, revisions, adaptations and/or derivations of and/or to an experience, additional episodes of an experience, and otherwise create, edit, publish, distribute or otherwise interact with an interactive experience. In general, these tools may be provided through any machine readable medium, such as the type described above and including over the Internet.

For example and in accordance with at least one embodiment of a tool for use with interactive experience, FIG. 17 is a diagram of an exemplary webpage 1700 layout of a portion of an interactive experience providing entry into an “experience” construction (or “design”) tool. Such tool may be available, for example, to third party developers, artists, authors, creators, publishers and others (hereafter, collectively “editors”) associated with interactive experiences, such as those persons involved in the development of interactive game content, interactive advertising content, interactive training content, interactive support desk or “help” desk services and other forms of interactivity. In at least one embodiment, the exemplary design tool of FIG. 17 may be utilized by an editor to create one or more episodes of an interactive game as described above, including video clips and web-based games. In another embodiment, the design tool may be utilized by an editor to create an entire interactive advertising or multimedia experience for a participant to a website, such creating an advertisement or an experience that incorporates other multimedia presentations, such as television programs or movies. In certain embodiments, participants in one or more interactive experiences may also be editors for the interactive experience or derivatives thereof. For example, a participant in an interactive game might provide new “tools” such as a magic wand and content associated therewith, that enables the participant to adapt the interactive experience such that their game play is enhanced. Such participant is acting as an “editor,” when creating the new tool and providing any branching or other functionality necessary to integrate the tool into the interactive game, and is also acting as a participant when wielding the new tool during the interactive game. As such, it is to be appreciated that the delineators between whether any given person or device (including automated devices and/or processes) associated with an interactive experience is acting as a participant or an editor is contextual and can vary accordingly.

It should be appreciated that the webpage 1700 of FIG. 17 may be received and displayed by any computing device, via any network connectivity, as described above. For example, the webpage 1700 may be received by a personal computer and displayed on the display device of the computer. In another example, the webpage 1700 may be received and displayed on a handheld computing device, such as a cellular phone. In general, an editor may access the webpage 1700 using any computing device configured to provide access to the Internet or any other network providing access to tools used in the creation, editing, publishing or otherwise of interactive experiences, including, but not limited to the production of interactive games. Further, as shown in FIG. 17, the exemplary webpage 1700 may include some text 1702 introducing an editor of the webpage to the concept of user-created content. In addition, the webpage 1700 may also include one or more buttons 1704-1710 or links to access one or more additional web pages that may include portions of the design tool. The buttons 1704-1710 may be selected by the editor using an input device to the computing device through which the editor is accessing the webpage 1700. For example, the editor may use a keyboard or mouse of a personal computer or laptop to select the buttons 1704-1710 or links. In another example, the editor may use a stylus or the editor's finger to select the buttons 1704-1710 on the display screen of a handheld computing device. Further, it should be appreciated that the webpage 1700 shown in FIG. 17 is merely exemplary and may take any form and design. Thus, the buttons 1704-1710 may be of any shape, may simply be links to the webpage, may include a descriptor or not and may be of any color. In general, the webpage 1700 may take any form known or hereafter developed for a website design.

In one embodiment, a plurality of buttons 1704-1710 may be provided in the webpage 1700, with each button linking to a webpage containing at least a portion of the design tool. In addition, aspects of the design tool may differ between the pluralities of links. For example and as shown in FIG. 17, one of several storylines may be accessed by the editor through the buttons 1704-1710. In particular, a first button 1704 may link to a webpage containing a design tool configured for a “Sunken Galleon” storyline, a second button 1706 may link to a webpage containing a design tool configured for a “Peruvian Gold” storyline and a third button 1708 may link to a webpage containing a design tool configured for a “Stolen Art” storyline. In general, these buttons may link to any modified design tool webpage associated with a storyline, including space adventures, western, romance, or for any other theme or genre.

In addition to the storyline specific buttons 1704-1708, a “General” button 1710 or other separately marked button may also be provided in the webpage 1700. The general (or non-storyline) button 1710 may link to a webpage providing a general content development tool with no specific ties to a particular storyline. Other buttons (not shown) may be provided that link to a design tool for advertisements, multimedia presentations, auditory-related presentations (such as music videos, songs, and other forms of content) or document editing. In general, the webpage 1700 may provide one or more links to one or more design tools for an editor to create any type of multimedia presentation and interactive experience.

FIG. 18 is a diagram of an exemplary webpage layout 1800 of a tool available to third party developers for developing one or more interactive experiences. As shown in FIG. 18, the tool is depicted in the context of creating an interactive gaming experience, it is to be appreciated however, that the tool may be used to create any interactive experience including, but not limited to, those directed to gaming, advertising, movies, soundtracks, training manuals, customer support functions, and any other form of interactivity between one or more persons and a collection of content. The webpage 1800 illustrated in FIG. 18 is just one example of a layout of the design tool accessible from the introductory webpage providing tools and features to an editor of the design tool to create an episode of an interactive game or other interactive multimedia experience for one or more participants. Therefore, one or more of the features described below may not be included in the webpage 1800, additional features or tools may be provided and the overall appearance and layout of the available tools may be altered from embodiment to embodiment. Thus, any video editing, interactive experience or game play form of a/v/d/ content, features or functions, known or hereafter developed, may be included as part of the design toolset presented in the displayed webpage 1800 of FIG. 18.

The webpage 1800 may be provided to or accessed by an editor, for example, by selecting one of the buttons or links illustrated in the webpage of FIG. 17. The webpage 1800 may also be accessed directly, for example, by inputting the appropriate uniform resource locator, or similar identifier, into a navigation bar of an Internet browser. The webpage and functionalities provided by it may also be automatically populated onto a participant's display, for example, during an interactive polling session, wherein the webpage requires the participant to act as an editor and specify the next topic(s) of interest to them. Thus, it is to be appreciated that the webpage and functions associated therewith may be presented to an editor or to a participant (who then functions as an editor) at any time and may be presented manually, semi-automatically and/or automatically.

In at least one embodiment, the features and functions included in the design tool webpage 1800 may be configured to correspond to a particular storyline, including those, for example but not limited to, provided for buttons 1704-1708 of FIG. 17. In one or more embodiments, the features and functions may include more general design tool features, functions and/or forms of content. The features included may be additionally, separately and/or alternatively configured to provide design tools for any type of end product, including specific types of end products such as design tools to create music videos, advertisements, television episodes, and/or other forms of content.

In one or more embodiments, the webpage 1800 of FIG. 18 may include design tools to aid an editor in the creation of an episode of an interactive experience, such as an interactive game, as described above. More particularly, the design tool may be utilized by an editor to create an episode of a Peruvian Gold storyline and may be accessed by selecting button 1708 from the webpage in FIG. 17. Thus, the design features illustrated in FIG. 18 may be configured specifically to aid an editor with use of the features to create an episode of a Peruvian Gold treasure hunter interactive game, similar to the episodes described above. As such, the design tool webpage 1800 may include a title 1802 that identifies the particular episode storyline and a link 1804 to a summary of the plot of the storyline to aid the editor in creating an episode of the story. Further automatic editor functions may also be provided, whereby based upon a participants and/or editors profile, as the case may be, the storyline is automatically populated. It should appreciated that the user profile may be generated based upon one or more responses to one or more inquiries by the participant during, before or after one or more interactive experiences. In essence, the automatic editor function utilizes a users (editor or participant) demographics, psychographics, habits, profile and other identifying information, characteristics and/or traits to automate the editing and creation of an interactive experience that is compatible with the user's profile and/or in synch with a desired progression of interactive experiences, such as a plot or storyline.

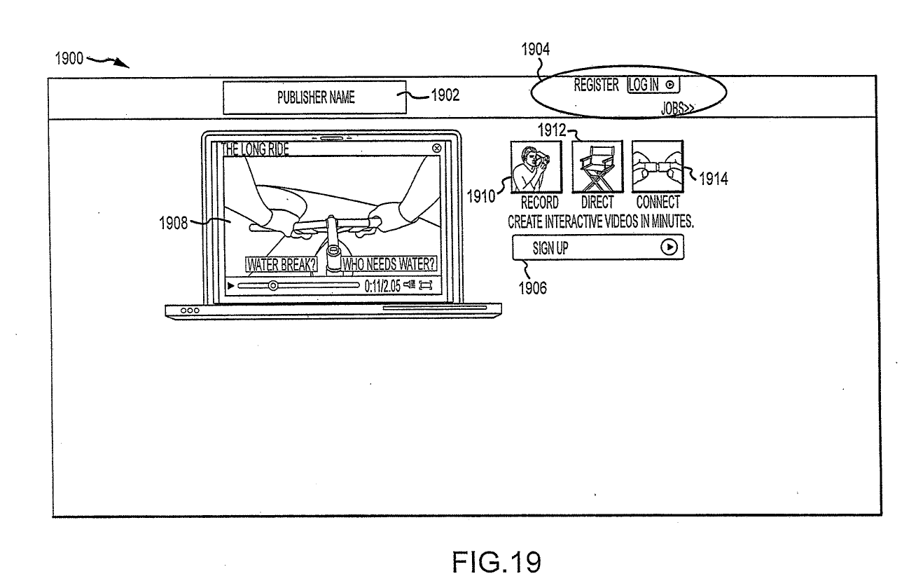

More specifically, the design tool webpage 1800 may include a plot structure diagram 1806 that may provide an outline of the video clips, games, dialogue branches, and other options that may form the content, sequence and/or flow of an interactive experience and/or of one or more episodes associated with a given interactive experience. In general, the presented plot structure may take the same form as described above with reference to FIGS. 1-15 above and may include the same type of content as described. However, in the case of a participant/editor-created episode, the video clips that form a portion of the episode content may be provided by the participant/editor or obtained elsewhere. In addition, the particular games and dialogue choices of the episode may be selected or supplied by the editor through the design tool 1800. In general, the plot structure diagram 1806 shown may be the default structure as the plot structure for the participant/editor-created episode. In some embodiments, however, the design tool 1800 may also include a link 1808 to another webpage that allows the participant to independently edit and create their own plot structure diagram. As discussed below, FIG. 19 provides an exemplary tool by which an editor may create a sequence of content in order to produce an interactive experience.

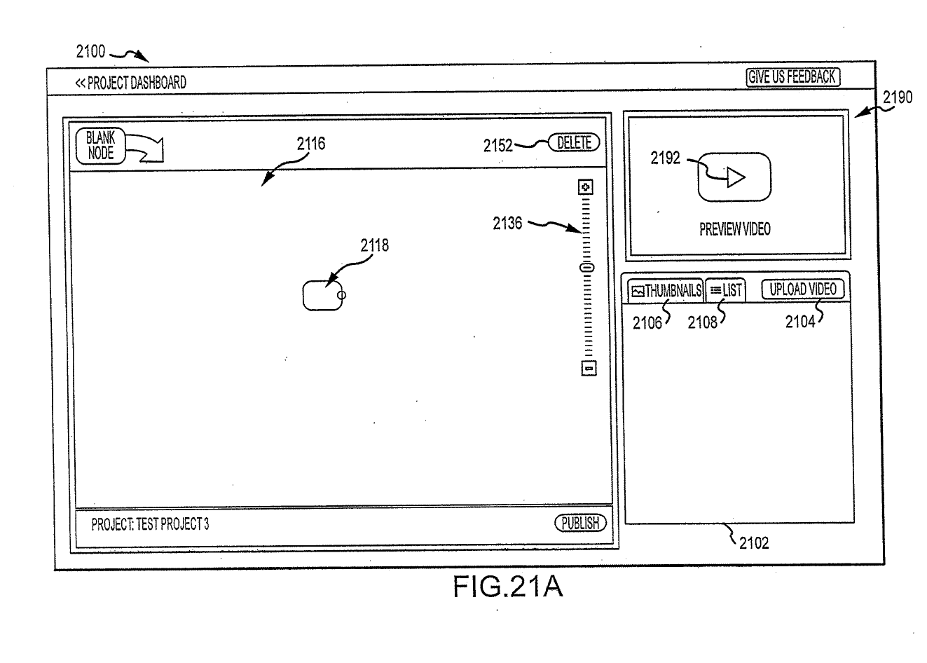

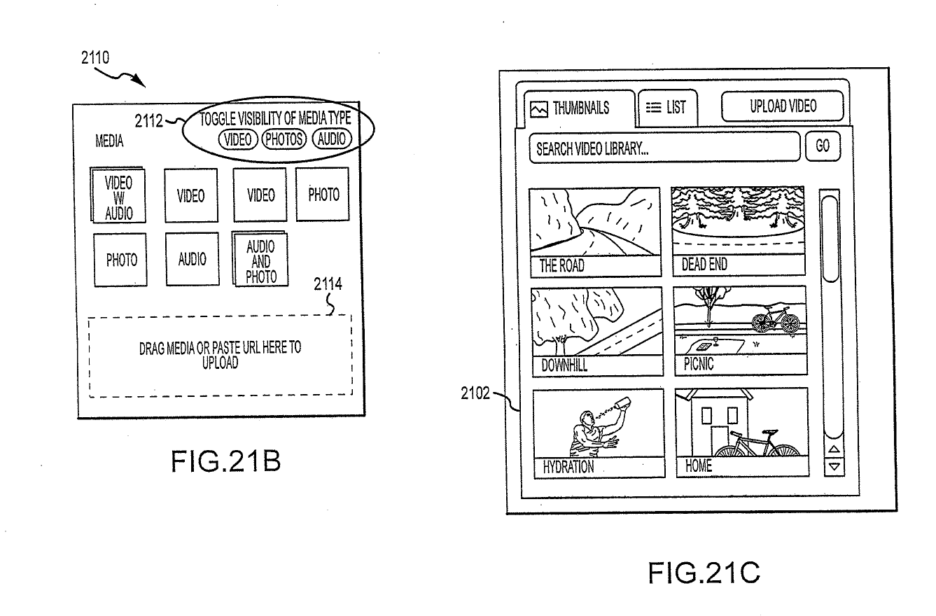

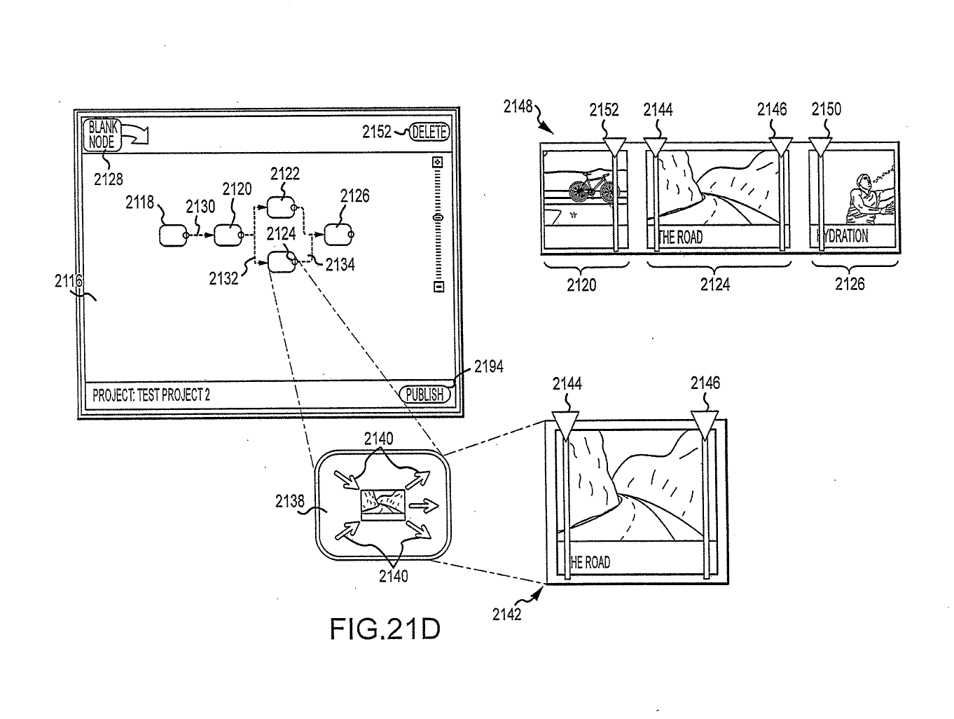

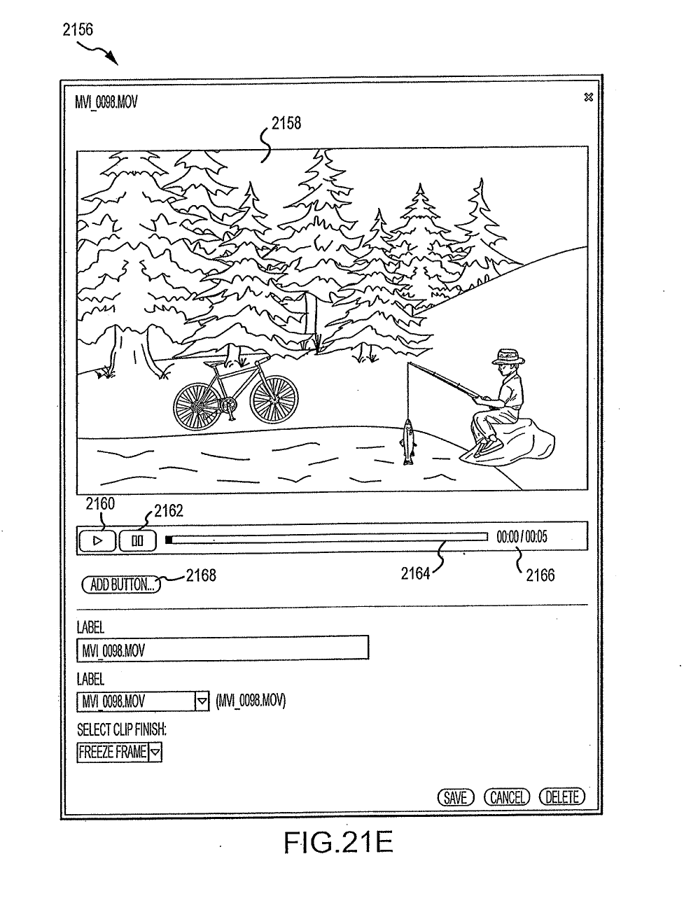

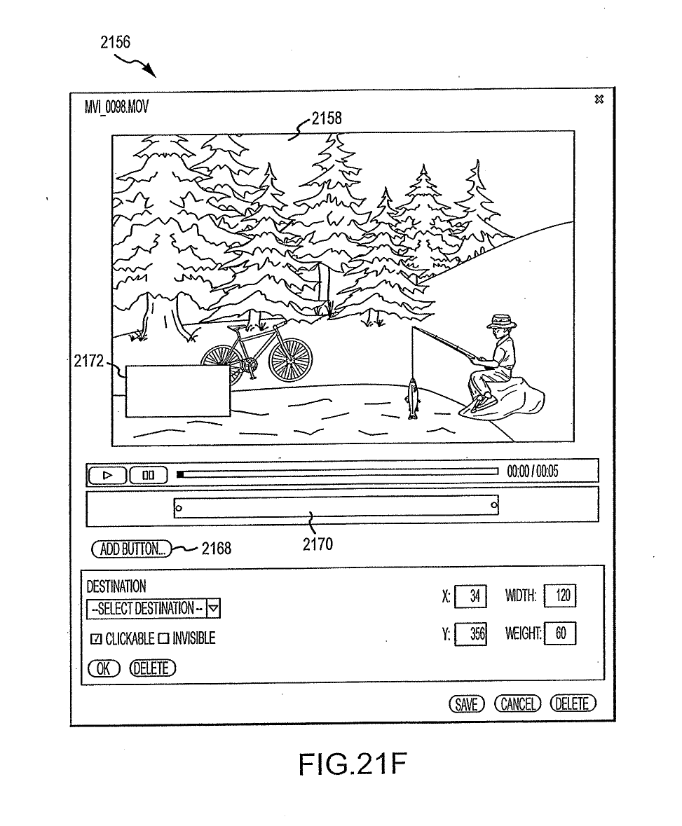

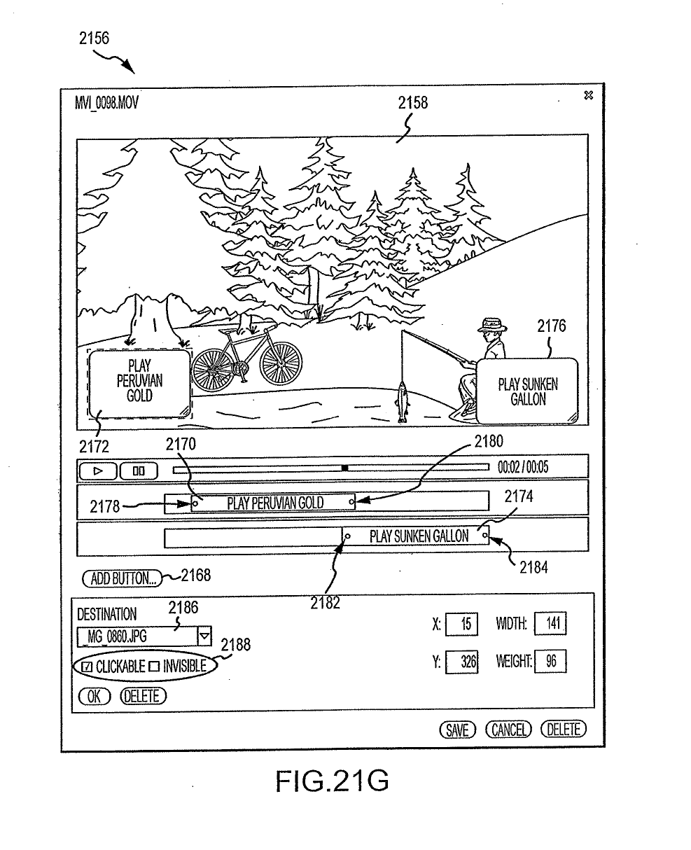

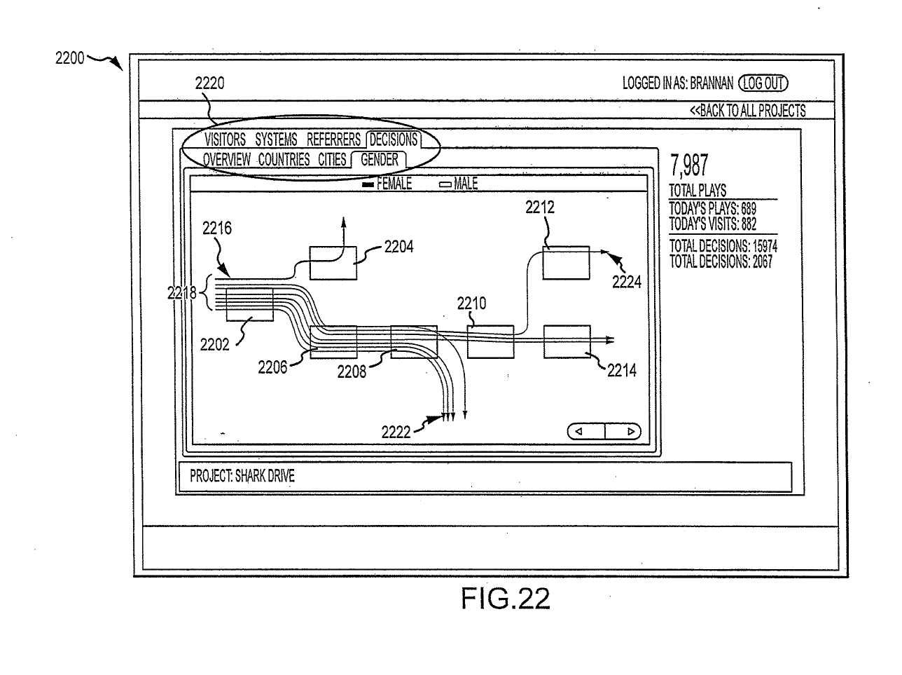

In at least one embodiment, a plot structure design may provide a structure that an editor may use to create one or more episodes. For example, the plot structure design may include one or more shapes that represent a particular portion of the episode. As shown in FIG. 18 for one exemplary embodiment, the light-colored circles may represent points in the storyline of a puzzle or pay-off, while dark colored circles may represent points of branches within the storyline. The lines connecting the circles may represent video segments of the episode that may be provided by the user during creation of the episode. In this manner, the user may provide the separate elements of the episode (games, dialogue choices, video clips) that make up the episode content as defined by the plot structure diagram. In another exemplary embodiment, show in FIG. 21D and discussed in greater detail below a plot structure diagram may include multiple nodes that are linked together to create an interactive experience.

Referring again to FIG. 18, beginning with the video clips, an editor using the design tool 1800 may upload, or otherwise make available, one or more video clips from any computing device. Once available to the design tool, a first video clip may be displayed to the editor in the video clip bar 1810. In addition, the design tool 1800 may include one or more in-point sliders 1812 and one or more out-point sliders 1814 that may be manipulated by the editor to determine the beginning and ending of one or more segments of the first video clip. As should be appreciated, the running time of any of the video clips for any portion of the editor-created episode may be constrained by a minimum duration and a maximum duration to fit within the episode structure. Thus, the in-point slider 1812 and out-point slider 1814 may be utilized by the editor to ensure the first video clip is of a proper length to fit within the storyline constraints. In one embodiment, to set the sliders, the editor may select a slider and slide it along the video clip bar 1810 to the desired position. In other embodiments, time-offsets, points and clicks and other techniques for designating one or more start and end locations for a given content may be utilized.

Video clips between branching points within an episode may also comprise a plurality of uploaded video clips. Thus, the design tool 1800 may provide an editor with the ability to combine several video clips to create the episode segments. For example, once the beginning and ending points of the first video clip is set by the editor, the first video clip may be dragged (utilizing an input device to the design tool) into the sequence timeline box 1816. A portion of the first video clip may then appear within the sequence timeline box 1816. To add to the video sequence, a second video clip may then be uploaded by the editor into the video clip bar 1810 and edited with the in-point slider 1812 and out-point slider 1814, as described above. Once edited, the second video clip bar may also be dragged into the sequence timeline box 1816 to append the second video clip to the first video clip. Through this process, the editor may utilize the design tool 1800 to combine a plurality of video clips to create one or more portions of an episode.

At any point during the creation of the sequence, the editor may preview the sequence by utilizing the input device to select the “Preview Clip” button 1818. Upon selection, the videos comprising the sequence may be displayed in the video view window 1820. As new video clips are added to the sequence, the editor may keep track of the changes and overall length of the sequence through the use of the “Preview Clip” button 1818 and video view window 1820. In this manner, the editor may utilize the design tool 1800 to create one or more video clips that comprise portions of the interactive game episode.

Further, as described above, the episode may also include one or more dialogue choices to determine the different story branches that the participant may experience. To create these branching dialogue choices, the editor may select one of the circles within the episode plot structure 1806 that represents a branching point. Upon selection, the design tool 1800 may provide a branching interface to the editor through which the user may provide text to be displayed to the participant during play of the game. This text may comprise a question with several options for answers. In addition, the branching interface may allow the editor to determine which branch of the storyline corresponds to which possible answer such that selection of one answer by the participant provides a path through one particular branch of the storyline.

As also described above, the episode may include one or more games or puzzles that the participant may interact with during play to increase the overall experience of the interactive game. For an editor-created episode, these games may be selected from the design tool 1800 and placed within the episode. In one embodiment, the design tool may include a list of possible puzzles 1822 that the editor may select from. For example, the editor may determine, at a point in the plot structure 1806 where a puzzle may be placed, that a sliding lock game should be encountered. To select the sliding lock game, the editor may select the sliding lock box and drag the box to the desired puzzle circle in the episode plot structure 1806. In this manner, the editor of the design tool 1800 may select one or more puzzles to include in the editor-created episode to enhance the experience for a participant of the episode.

In some embodiments, an editor may create and upload a puzzle into the design tool interface 1800. For example, the editor may create a puzzle using a recognized software application. Once created, the editor may utilize the design tool 1800 to upload the puzzle in a similar manner as uploading a video clip. Once uploaded or otherwise made available to the design tool 1800, the created puzzle may be added to the list of available puzzles 1822 for selection by the editor and inclusion in the episode. In addition, the puzzles may be customizable by the editor prior to inclusion into the editor-created episode. In one embodiment, the design tool 1800 may include a list of puzzle skins 1824 that may be selected to configure a selected puzzle. For example, the list of puzzle skins 1824 may include a list of themes that correspond to possible storylines. Thus, an “Ancient Peru” skin to the puzzle may be provided that corresponds to the Peruvian Gold storyline. To add the custom puzzle skin to the puzzle, the editor may drag, or otherwise select, the corresponding box from the puzzle skin list 1824 into the desired puzzle box in the puzzle list 1822. Once combined, the editor may drag the puzzle into the plot structure 1806 as described above. In this manner, the editor may customize the puzzles included in the editor-created episode to better match the theme and storyline of the episode. In at least one embodiment, dependencies between puzzles, skins, video clips and/or other content may be specified by an editor of an episode and/or a provider of the design tool 1800. For example and not by way of limitation, in at least one embodiment, the selection of a particular puzzle necessarily includes a selection of a corresponding video clip, and vice versa, such that upon placement of the puzzle in the plot structure, the corresponding video clip is suitably placed also in the plot structure. In this manner, related content can be grouped and/or otherwise associated to expedite the creation of an episode and also to provide consistency in the interactive experience presented by an episode.

At any time during the population of the plot structure 1806 for the editor-created episode with video segments, branching points, dialogue choices, puzzles and other content the episode may be previewed by the editor by selecting the “Preview Game” button 1826. As with the “Preview Clip” button 1818, an editor may utilize the “Preview Game” button to keep track of the changes and overall length of any given episode.

At any point during the episode creating process, including but not limited to when the editor has completed editing, for example, by populating the entirety or a desired portion of an episode plot structure, the interactive experience may be published for participants to experiencing. In at least one embodiment, publishing may occur by the editor selecting the “Finish & Publish” button 1828. Upon selection of button 1828, the completed episode may be uploaded, or otherwise made available, to a server that may be accessed by one or more participants in or to the interactive experience, for example participants of an interactive game. In some embodiments, the episode may be stored on a server hosted by a third party or otherwise. For example, a corporation may utilize the design tool 1800 to create an episode that includes advertisements for the corporation. Upon completion, the episode may be stored by the corporation on their server and/or website for play by a potential consumer. In another example, the creator of the episode may upload, store or otherwise make available the episode to a website, or other computer addressable location, hosted by a publisher of the design tool 1800, the editor or any other person or entity, such storage location may utilize one or more local or remote servers. Similarly, the episode may be provided to the general public from an editor's or publisher's homepage. In general, upon completion, the episode may be accessible by the general public or, in another embodiment, to a limited subset of the public from a computing device connected to a network.

In at least one embodiment, the design toolset may be configured to provide linking between several episodes to create a series of editor-created episodes. Such series may be posted by a publisher or other person having access and permission to each of the episodes, as one or more episodes in a series may not be created by the same editor. For example, an editor may create three episodes that depend upon and continue an already developed and created storyline. Thus, the editor may utilize the design tool to link the previously created episodes to the new episodes created by that editor and thereby create a series. In general, any number of episodes may be linked together to create a storyline series. In addition, other options typical of a series for providing an interactive experience to one more participants may be provided through the design tool. For example, when a series is created, the design tool may be configured to send emails, text messages or other forms of communications, including but not limited to in-game messages, to one or more participants, similar to those messages described above. In one or more embodiments, only subscriber participants may receive such messages and any ability to edit or create one or more existing or new episodes, as the case may be. Such messages may include further clues to progress the storyline through the series and increase one or more desired aspect of the interactive experience for the participants receiving and/or responding to such messages.

In at least one embodiment, a rating or voting system may be associated with one or more editor-created episodes. For example, participants of an episode may be provided with an option to score or rate one or more editor-created episode, series, or other segments, content, features and/or functions of an interactive experience. Such rating may, for example, provide an indication as to the level of enjoyment one or more participants experienced with respect to an episode. Content controls and other functions intended to ensure a given level of decency and/or participant enjoyment in an interactive experience may also be provided in one or more embodiments. More specifically, an editor-created episodes may be flagged or otherwise identified for inappropriate, indecent or otherwise undesirable content such that other participants, editors, publishers and others involved with an episode, a series of episodes or a catalog or collection of multiple series can self-police the content created by other editors and others and thereby discourage and/or prevent inappropriate content from entering into an offering of one or more interactive experiences, such as an interactive gaming system.

With reference to FIGS. 19 to 21 another embodiment is depicted of an exemplary tool by which an editor may create a sequence of content in order to produce an interactive experience for one or more participants. As discussed above, an interactive experience can provide any combination of content paths and episodes. An editor may create an interactive experience by visiting one or more webpage tools providing interactive experience creation, editing and/or publishing tools. As used herein, an interactive experience is “published” when it is provided, or otherwise made available, to one or more persons for participation therewith. An interactive experience may be in draft, final or any form in-between and may be published by any known methods of communication including, but not limited to, posting to a social media site or service, email, or other form of communication. An interactive experience may also be created using any suitable device including, but not limited to, personal computers, tablets, mobile devices and other computing devices.

More specifically and as shown in FIG. 19, a first screen for one embodiment of a tool for creating an interactive experience is provided. As shown for this embodiment, an introductory page 1900 may be provided at which an editor may login to a website, or access an application accessible on or using a mobile device, access an application that provides one or more tools for interactive experience editing. In this embodiment, such tool 1900 may include an identification of the publisher of the tool, as shown in field 1902. Field 1902 may include a link to one or more applications which are provided by the publisher, including for example, applications which enable a creditor to access the tool using a mobile device, personal computer or any other type of computing device. Field 1902 may also provide a selection by which an editor can select from a listing or other identification of one more publishers of interactive experiences.

As shown in FIG. 19, an embodiment may include a login/registration area, such as areas 1904 and 1906, in which an editor can identify themselves for a first or repeat time. A repeat editor may be automatically identified to the tool 1900, for example, based upon an Internet Address, MAC address associated with a computing device, an authentication code, a cookie, or using any other known in the art automatic user identification processes or combinations therein. An introductory page, such as page 1900, may also include one or more introduction areas by which the tools, features and functions of the tool are presented. For example, an introductory video may be presented in video window 1908, while various descriptors on application functionality, such as “record”, “direct,” and “connect” may be provided via buttons 1910, 1912 and 1914, respectively.

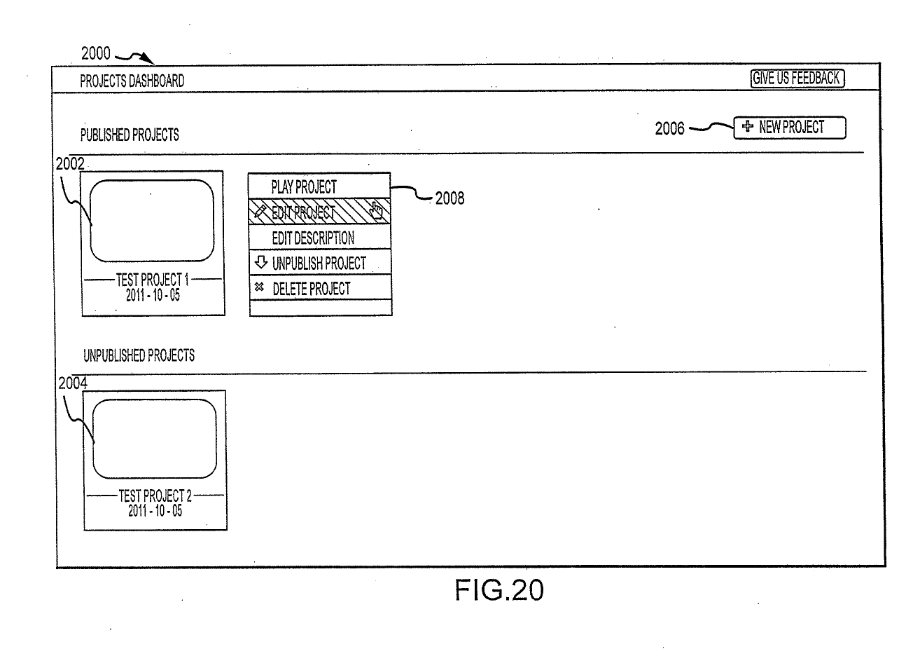

Upon a first time editor registering with the provider of the tool, if required for any given embodiment, or upon a repeat editor accessing the tool, the editor may be presented with the option of creating one or more projects or accessing previously created projects via a project dashboard. FIG. 20 depicts one embodiment of a project dashboard which may be presented, for example, in a pane of a window or a section of a display screen. Other information, such as contact information for a publisher, editor log-in information, and other information may be provided in other panes, borders, pop-ups or otherwise with the project dashboard pane 2000. As shown for the embodiment of FIG. 20, the project dashboard 2000 may include an identification of one or more projects such as published project “Test Project 1” and unpublished project “Test Project 2”, as identified by project 2002 and 2004. The dashboard pane 2000 may also include a button, or other user interface mechanism which enables an editor to create a new project, such as new project button 2006. For published projects, upon highlighting, tapping, positioning a cursor over or otherwise selecting a project, various options may also be presented, as shown in options field 2008. Exemplary options may include, but are not limited to, “play project”—which upon selection presents the editors with an interactive experience viewer (not shown) in which a project in its entirety, or a segment thereof, may be presented, “edit project”—which upon selection presents the editor with tools, features and functions which enable editing of an existing, published project, “edit description”—which enables an editor to modify a description, keyword, tag, or other form of identifier, such identifiers may be useful in characterizing any given project/interactive experience for searching and identifying on the Internet or otherwise, “un-publish project”—which enables an editor to make an interactive experience unavailable to one or more persons, and “delete project”—which makes an interactive experience unavailable to all, including the editor themselves. Similar, additional and/or alternative functionality may be provided for published projects and/or unpublished projects, as desired for any given implementation of an embodiment discussed herein. Further, editors may use touch screen or comparable user interfaces to access the tools. Such interfaces may provide various interface tools and techniques including, but not limited to, the combining of common interactive experiences into folders by tapping or double tapping to zoom in or out, the scrolling through a pane by horizontal, vertical or other finger swipes and other commonly known user interface techniques. It is to be appreciated that the dashboard 2000 and other tools provided by any given embodiment may utilize any desired user interface techniques, features and/or functions to identify and allow access to projects.

Referring now to FIGS. 21a to 21G, in at least one embodiment of the tool shown in FIGS. 19 and 20, an editor 2100 (or other form of user interface) may be provided. Such an editor 2100, in at least one embodiment, provides one or more panes in which an editor can select content for use in an interactive experience, such as content selection pane 2102. As shown in FIG. 21a, the content selection pane 2102 is unpopulated and awaiting an editor's uploading of content, for example, video content, form data, lists, mapping content, applications supporting micro-transactions, such as those used for casual user play of a gaming interactive experience, geo-caching applications by which one or more participants participate on a treasure hunt that may be actual or virtual, applications supporting audio and video calls between participants and others, and other forms of application programs and content may be accessed. In certain embodiments, the content uploaded into content selection pane 2102 or accessible therefrom, may include a link or trigger that launches content, such as a movie or application. Content may come from any source, including but not limited to, a local or remote storage device accessible to a user and/or in communication with the editor's computing device or application operating thereon. Exemplary sources of content include live or recorded content, such as that produced by a still or video camera. Other exemplary sources include a site or source of photographs, videos, music or any other form of content, such as content provided by: FACEBOOK, which is provided by Facebook Inc. of Palo Alto, Calif.; FLICKR which is provided by Yahoo Inc. of Santa Clara, Calif.; BRIGHTCOVE, which is provided Brightcove Inc. of Cambridge, Mass.; OOYALA, which is provided by Ooyala Inc. of Mountain View, Calif.; VIMEO which is provided by Vimeo LLC of New York, N.Y.; VIDYARD, which is provided by Vidyard Inc. of San Jose, Calif., YOUTUBE, which is provided by Google Inc. of Mountain View, Calif.; ITUNES, which is provided by Apple Inc. of San Mateo, Calif.; OPEN TV, which is provided by the Open TV Inc. of San Francisco, Calif.; and others. In at least one embodiment, any source of content which are accessible to an editor may be identified in content selection pane 2102, for use in an interactive experience. In at least one embodiment, a publisher of the tool may provide pre-identified content for use by an editor. In other embodiments, such content, features and functions may be manually, semi-automatically or automatically populated in pane content selection pane 2102. The content available to an editor for uploading into content pane 2102 may originate from any device, hardware or software including, for example, mobile phone cameras, point-and-shoot cameras, video cameras, graphics processing applications, or other sources of content.

As shown in FIG. 21, one or more user interface features, such as “upload video” button 2104, thumbnails button 2106 and list button 2108 may be utilized to select, filter, identify or otherwise make available content available to an editor in content selection pane 2102. While the “upload video” button 2104 specifically references “video” content in this embodiment, it is to be appreciated that the button 2104 may be used to upload other forms of content and/or that additional buttons may be provided for the uploading of content, as determined for any given implementation of an embodiment discussed herein. For example, FIG. 21B shows another embodiment of a content selection pane 2110 that may be utilized wherein one or more content selection buttons 2112 may be selected to upload, select, filter or otherwise present for incorporation into an interactive experience content by use of content selection pane 2110. For example, the available content may be filtered, categorized or otherwise identified based upon whether it is a video, photo or audio. Other filters may be utilized in other implementations, as desired.

In one embodiment, one or more fields, such content selection field 2114, may be provided by which content, features and functions may be made available for incorporation into an interactive experience by the common drag and drop user interface technique. Other techniques for identifying content/features and/or functions available for incorporation into an interactive experience may be utilized, as desired.

FIG. 21C provides one example of a content selection pane that has been populated with numerous video content. As shown for this example, such video content generally relates to a bicycling interactive experience with video clips titled as “the road,” “dead end,” “downhill”, “picnic,” “hydration,” and “home.” It is to be appreciated that when content is populated into the content selection pane 2110, such content may be described or otherwise characterized by the editor or others. Such description and/or characterization may be pre-populated, for example, in meta data provided with the content including positional data, characterized by the editor real-time, automatically characterized, for example, using facial recognition, topology recognition and similar recognition software features or functions, or otherwise described and/or characterized. Such descriptions and/or characterizations, if any, can occur at any time. Such descriptions and/or characterizations of the content may also be automatically extended into an interactive experience and/or the descriptions thereof when published, thereby assisting participants in identifying content of interest to them and others. The extension of descriptions and/or characterizations, in at least one or more embodiments, may occur automatically or may require an editor to “opt-out” of the providing and/or associating of descriptors and/or characterizations with a given interactive experience. Further, such descriptions and/or characterizations, in certain embodiments, may be configurable by a person identified in any given content with or without the editor's permission. For example, a person presented in a content segment may desire to delete, make indeterminable, edit, or prevent or restrict the access by others to such content. An automated program may be provided which enables a publisher of the tool to may provide manual, semi-automatic and/or automatic content editing capabilities which comply with any given content provider's, country's or others expectations of content protections, such as digital rights management requirements, privacy, decency, child protection or other laws, regulations, restrictions or expectations regarding any given content. Descriptors and characterizations of content may also provide limitations on use, for example, a limitation that the content can only be used if specified attribution is provided. Content may also include linkages to other forms of content which must be utilized in conjunction with the underlying content. For example, a video segment from a television show may require a linkage to an advertisement that must be presented before the video segment can be presented during an interactive experience. As such, it is to be appreciated that the content made available for use in an interactive experience may include and/or be associated with one or more business rules governing the use thereof.

Upon the uploading of content into the content selection pane 2102, for example, as shown in FIG. 21C, an editor may select such content for presentation on their computing device without requiring the use of any other device. In at least one embodiment, content is populated into the content selection pane 2102 with any codec's, application program interfaces or other software programs which are needed to present and provide any desired level of interaction with the uploaded content. In at least one embodiment, an editor can verify that any uploaded content operate and perform as desired from a single editor, such as editor 2100.

Referring again to FIG. 21A, in at least one embodiment, editor 2100 includes an editing canvas 2116. An editing canvas, such as canvas 2116, is functionally the area upon which an editor creates an interactive experience. An editing canvas, such as canvas 2116, is created in a pane of the editor 2100 for every interactive experience and is created upon the initiation of a new project. Each canvas, upon creation thereof, includes at least one node, such as node 2118. In at least one embodiment, a node is a location in an interactive experience at which a content, feature or function may reside. A node is represented on the editing canvas 2116 as a location in time and/or space. As discussed above with respect to FIGS. 1-15, an interactive experience may include a plurality of operations for which content may be presented to a participant based upon one more criteria. In FIG. 21A, a node, such as node 2118, may be utilized to identify when an operation (provided to a participant during an interactive experience) is to occur relative to other operations. As shown in FIG. 21D, multiple nodes 2118, 2120, 2122, 2124 and 2126 may be populated onto the editing canvas 2116 by utilizing node insertion button 2128. A storyline, or plot line, may be created between nodes by suitably selecting a first node, such as node 2118, and selecting a second node, such as node 2122, while the first node is still selected. Similarly, connections between nodes, such as connections 2130, 2132 and 2134, can be established, for example, on a touch sensitive screen, by placing one's finger on a second node and dragging the node to the first node, thereby indicating that the second node is subservient, or otherwise occurs later in time or sequence, to the first node. In another embodiment, the process of creating a linkage between any two nodes may work in reverse of that described above with an editor selecting a first, precursor node and dragging their finger from the first node to a second, subservient node. In other embodiments, other processes for establishing a hierarchy between a first and at least one second node may be utilized. Similarly, using a mouse and drawing tools one may draw lines between nodes, and thereby establish a connection, sequence or other relationship between nodes. It is to be appreciated that any method for creating and presenting to an editor relationships between two or more nodes may be utilized in at least one embodiment discussed herein. Further, such relationships may be presented to the editor in other than a visual representation, audible and other forms of communications, such as time delays between nodes, may be presented as desired. Similarly, relationships between nodes may exist, and be presented to an editor to exist, in any dimension, including three dimensional and even four dimensional, wherein time is the fourth dimension. As such, the canvas may be configured to facilitate the representation of nodes and relationships therebetween in any desired configuration, including as holographic, three dimensional or other representations.

As discussed above with respect to FIG. 18 and the episode plot structure diagrams 1806 discussed therewith, node structures may also be provided in a pre-populated format. For example, a publisher may desire for an interactive experience to include a preferred sequence of interactive content. An exemplary sequence might include: (a) node 2118 providing a location for an introductory video relating to a given product or service to be advertised, (b) node 2120 providing a location for an interactive inquiry to a participant as to their preference (for example, whether a preference existed for a convertible or a hard top automobile), (c) node 2122 providing a location for positioning content relating to a convertible driving experience, (d) node 2124 providing a location for positioning content relating to a hard-top driving experience, and (e) node 2126 providing a location for positioning content providing directions to the participant on where they purchase or test drive a vehicle as presented in the previously selected driving experience. Thus, it should be appreciated that in one or more implementations of an embodiment discussed herein, publishers may provide and/or specify to an editor an editing canvas 2116 ranging anywhere from a blank canvas to a tightly controlled canvas that specifies not only a plot or storyline structure, but, also the particular type of content that a particular node can be used to present during a given interactive experience.

In at least one embodiment, each node on the editing canvas 2116 may be populated with content selected from the content selection pane 2102. When a story line or plot is pre-populated, as shown for example in FIG. 21D, content may be suitably indicated for presentation at any given node. In one embodiment, content may be dragged and dropped from the content selection pane to a given node. In other embodiments, other methods for creating a relationship between a given node and any available content may be utilized. Further, it is to be appreciated that just as content selection pane 2102 identifies content available for use in an interactive experience, and does not necessarily indicate that such content is locally stored or locally available to the editor (that is the content available may be hosted elsewhere and the identification of the same in the content selection pane does not require the copying, transfer or other creation of content locally accessible to the editor), the editing canvas likewise does not require the local storage with or availability of content by the editor.

The editing canvas 2116 also may include one or more user interface controls that enable an editor to see an interactive experience at any desired level of detail or reference point. As shown in FIG. 21A and 21D, one embodiment of such a user interface may include a zoom bar 2136 via which an editor may enlarge or reduce any displayed portion of a story line or plot structure captured on the editing canvas 2116. Other forms of zooming in on or otherwise viewing content on a computing device may be utilized including, but not limited to, use of scroll wheels, double taps and any other known in the art techniques. In at least one embodiment, an editor is able to perform any desired content editing or creation activities from the editing canvas 2116 and/or the content selection pane 2102.

One embodiment by which an editor may edit content presented in a node on the editing canvas 2116 is shown in FIG. 21D. As shown for an embodiment wherein the content presented in the node is video content, the editing canvas may be zoomed in and onto a given node, such as node 2124, so as to focus on the node, as shown by node 2124 enlarged representation 2138. The enlarged representation 2138 of node 2124 may in turn be expanded or contracted, for example in the directions shown by expansion arrows 2140, as desired. In at least one embodiment providing a video as the content, the contents of a node may be further enlarged to present to an editor the contents at a high level of detail. For example, the expansion of node 2124 into enlarged representation 2138 may be further magnified into the expanded node representation 2142. It is to be appreciated that an expansion or contraction of a node from any first size to a second size may occur seamlessly. An editor may also crop or otherwise segment the contents of a node to present a desired segment selected from the whole when the node is active during an interactive experience. For example, with respect to expanded node representation 2142, cue-in and cue-out locations 2144 and 2146, respectively may be specified such that the video of node 2124 would begin at cue-in location 2144 and end at cue-out location 2146.

As further shown in FIG. 21D, by multi-node segment 2148, multiple nodes and the content thereof may be selected and zoomed in, magnified or otherwise presented to an editor for editing. More specifically, the editing canvas may enable an editor to view, with respect to any given node such as node 2124, some of all of the content provided in a preceding node, such as node 2120, and/or in a trailing node, such as node 2126. Cue-in locations and cue-out locations, if any, for the content presented by each node may be presented, such as cue-in locations 2144 and 2150 and cue-out locations 2146 and 2152. Similar content editing functions may be provided on the content selection pane 2102. As such, it should be appreciated that the editing canvas 2116 and/content selection pane may be utilized, in at least one embodiment, by an editor to select one or more segments of content identified to one or more nodes.

As further shown in the embodiment of FIGS. 21A and 21D, a delete button 21524 may be provided by which one or more selected nodes can be deleted from an editing canvas 2116 for an interactive experience. Other known methods of deleting content from a pane of an application program may be utilized in other embodiments.

The zooming in and magnification type editing discussed above with respect to FIG. 21 D may be insufficient for editing a given interactive experience. As such, for at least one embodiment, an editing pane may be provided. Such editing pane may be activated, for example, by selecting the node provided the content to be edited. Such selection may occur by double clicking on a node, double tapping the node, voice command or other selection technique. In at least one embodiment, upon selection of the content for a node for editing, an editing window may be presented, such as editing window 2156 as shown in FIG. 21E. In at least one embodiment, the editing window 2156 may include a viewing pane 2158, in which the content associated with the selected node may be presented. In the case of content consisting of video or motion pictures, the editing window 2156 may include commonly known control and status display features, such as the exemplary play button 2160, pause button 2162, elapsed play bar 2164 and elapsed/total time counter 2166.

As further shown in FIG. 21E, an editing window 2156 may be configured, in at least one embodiment, to include an “add button” such as button 2168. Upon selection, button 2168 presents a control element, such as first control element 2170 and a descriptor tag, such as first descriptor tag 2172, as shown in FIG. 21F. As shown in FIG. 21G, one or more buttons may be associated with any given node, resulting in the presentation of respective first and second control elements 2170 and 2174 and, optional, respective first and second descriptor tags for 2172 and 2176. In at least one embodiment, each button acts as a linking agent, which upon selection by a participant during an interactive experience, leads to a branching or other event by which additional and/or alternative content is presented. Each control element may be configured to enable an editor to provide a descriptor which is presented to the participant in a corresponding descriptor tag, 2172 and 2176. For example, control element 2170 may be edited to specify “Play Peruvian Gold,” this descriptor may be correspondingly presented in first descriptor tag 2172. Similarly, control element 2172 has been edited to specify “Play Sunken Gallon,” which descriptor may be correspondingly presented in second descriptor tag 2176.

In at least one embodiment, an editor may specify when a given linkage is available for selection by a participant during the presentation of content associated with a given node. For example and as shown in FIG. 21G, cue-in, 2178 and 2182, and cue-out, 2180 and 2184, indicators may be respectively associated with the first and second control elements. The cue-in and cue-out indicators may be configured to determine when a branching event is possible and when the descriptor tag associated therewith is presented to the participant. In certain embodiments, as shown in FIG. 21G, two or more descriptor tags may be presented to a participant at the same time, as occurs when approximately two (2) seconds of the five (5) second content segment of FIG. 21G has been presented. In other embodiments, descriptor tags, if any, may be presented at only the beginning or end of a content segment.

In at least one embodiment, when a node is serially connected to a subsequent node, such as occurs for node 2118 with node 2120, descriptor tags may populate so as to provide an appearance of participant controlled branching, when no such participant control may actually exist, with respect to the content associated with node then being processed. In at least one embodiment, each control element includes a destination designation, as shown in FIG. 21G in destination field 2186. The destination designated in field 2186 identifies the node to which the interactive experience branches when a descriptor tag is selected by a participant.

One or more control check boxes, such as check boxes 2188, may be associated with each control element. In one exemplary embodiment, as shown in FIG. 21G, exemplary control check boxes may enable an editor to specify as to whether a descriptor tag is “clickable,” or “invisible,” wherein a “clickable” tag enables a participant to automatically jump to the destination associated with a tag, and an “invisible” tag does not appear on a screen but is still present should a user hover over or click upon a certain portion of content. For example, an interactive educational experience might include audible instructions to a toddler requesting their “clicking” on a cow, whereupon “clicking” upon the cow an invisible tag is also selected which results in the presentation of a mooing sound or other content. Other forms of control elements may be used in other implementations of the embodiments discussed herein examples include the use of filters, special effects, transitions, player frames and other control elements. Similarly, other forms of content may be specified for any given content selected for a node. For example, audio properties of a selected video may be specified, including but not limited to, the type of encoding/decoding used, the volume, and the track selected. Similarly, for a selected audio track, one or more video or graphical properties associated therewith may be specified, including but not limited to, the type of screen saver or album art to present during the presentation of the audio track. Other control aspects of content associated with a node may also be specified in various embodiments of an editor. For example, a control element may be provided by which an editor can specify what happens when an end of a content segment is reached and no further segments are branched therefrom. Such end of content scenarios may include termination of the presentation, a link back to a content catalog, a repeat of the last presented content, or the entire interactive experience or any other termination event sequence, as determined by an editor for any given implementation of an embodiment discussed herein. Thus, it is to be appreciated that by providing one or more descriptor tags and control elements, including but not limited to destinations and check boxes, an editor may seamlessly create a multi-nodal and branching interactive experience. The population of the control elements, descriptors tags and destinations may be automatically accomplished on the editing canvas 2116 by linking nodes, as discussed above, with descriptors being populated from the titles of the contents associated with any given node to which another node is linked.

Referring again to FIG. 21A, in at least one embodiment, nodes may be locked by an editor to prevent further editing thereof. When locked, an icon, such as a lock icon, a red box, or other designator may be used to indicate that a node and its branches to and there from are locked. It is to be anticipated that such a feature may be beneficial when multiple editors are collectively, and substantially simultaneously, editing a given episode, series or other interactive experience. When utilized in a multi-editor embodiment, each editor may be presented with a unique, or a common, content selection pane. Each editor may also be presented with a selected segment of nodes and content associated therewith. Depending upon editor's permissions, an editor may also be provided with a global view of an editing canvas for an interactive experience, such global view may permit, as desired for any given implementation, such global editors to exercise editing privileges for the entirety or less of the given interactive experience.

To view the functionality to be presented to one or more participants for a given interactive experience, project dashboard tool 2100 may include a preview pane, such as preview pane 2190. Preview pane 2190 may enable an editor to view the content populated into one or more nodes, including branching to and from nodes, prior to publication. In at least one embodiment, an editor may select any node containing content on the editing canvas, and then select preview button 2192, to initiate a presentation of the interactive experience from the selected node and thereon. By selecting upon a start or first node, such as node 2118 in FIG. 21D, an editor can view the entirety of an interactive experience. Corrective actions to the flow, presented content or other aspects of the interactive experience may be identified and modified or corrected utilizing any of the tools discussed above and other tools.

In certain embodiments, an editor may preview the experience using the same type of devices as which a participant may desirably access a given interactive experience. For example, one embodiment of an interactive experience may include a presentation video in node 2118 of a multi-person discounted virtual or actual shopping experience. Node 2118 may create a link, when the participant is so interested, in identifying friends and others that may also be interested in participating in the shopping experience, such identification may be provided by including in node 2120, for example, an content element that includes a linkage to one or more social media sites. Upon presenting to the participant (demo editor) which friends are interested in the shopping experience, node 2120 may present the participant (demo editor) with an option, a descriptor tag to shop actually, versus on-line. Assuming the participant selects such actual shopping tag, the interactive experience proceeds to node 2122 and provides the participant (demo editor) with actual driving or other directions to a store providing the discounted goods/services, such directions may be provided by accessing at node 2122 at content piece which may launch or access a mapping application. Such mapping application may then provide an actual directions from the participant's (demo editor's) present location to the nearest store providing the discounted goods/services. When an actual store is not convenient or the participant (demo editor) does not desire to travel, node 2120 may present a descriptor tag enabling the participant (demo editor) to shop virtually/on-line. When presenting a virtual shopping experience, node 2120 may actually link to or otherwise access an on-line shopping experience provided by the merchant/retailer associated with the discounted shopping experience. Finally, the interactive experience may conclude, for example upon the participant (demo editor) buying, actually or virtually, the discounted goods/services at which instance a feedback, survey or other messaging may be presented via content presented in node 2126.

Referring again to FIG. 21D, upon an editor determining that an interactive experience contains the content and linkages therebetween that are desired, the editor may publish the experience by selecting publish button 2194. An interactive experience may be published to any desired depository or source of the same. For example, an interactive video experience might be published to an online video site. Similarly, an interactive gaming experience might be published to a site providing interactive games. A corporate training seminar might be published to a corporate e-learning environment or otherwise. As such, it is to be appreciated that an interactive experience may be published to any desired source, device, destination, or otherwise. When published and accessed by a participant, the interactive experience may be configured to pre-cache content, such that upon a participant's selection of a tag leading to a branching option, some or all of the content associated with the branched too selection is already available for immediate presentation to the participant. In this manner, a substantially seamless interactive experience may be presented to a participant without regard to whether the content needed for such experience is locally or remotely stored and/or available. In certain implementation of one or more of the embodiments discussed herein, however, certain content segments may be stored on a participant's computing device to provide as substantially seamless of an interactive experience as possible, while be subject to practical system, device and content limitations. For example, in a geo-caching interactive experience, wherein a participant may travel to one or more physical locations not accessible to network, cellular or other communications infrastructure, a computing device utilized with the interactive experience may desirably be pre-loaded with those content segments that may be needed (based upon a branch a participant may take) but are not available for immediate access from a remote source. Similarly, a computing device may be configured to store and/or record, for archiving, profiling, or later downloading the branches taken by a participant during an interactive experience. Such branching information may be used to determine a user's profile, the efficacy of a given messaging, consumer preferences and other information useful to editors, publishers and others.

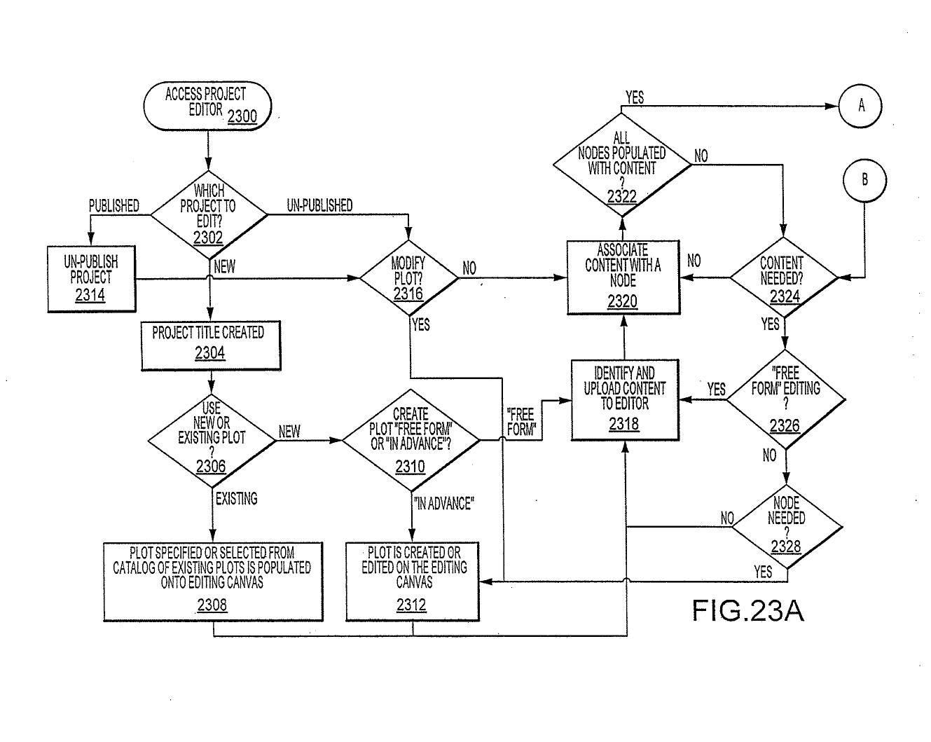

FIG. 22 presents one embodiment of an analytics tool 2200 that may be utilized by an editor, publisher, content creator, a computer based smart decision engine or others interested in identifying how one or more participants navigate a given interactive experience. As shown, analytics tool 2200 may be populated with the plot structure diagram utilized by an editor to create and publish a given interactive experience. More specifically, the one or more nodes 2202, 2204, 2206, 2208, 2210, 2212, and 2214, or a segment thereof, for a given interactive experience may be presented. As per the above discussion, each node represents a selection of content that may be presented to a participant during an interactive experience. As a participant navigates through the interactive experience, the participant's choices, dwell times, inputs and other information related to the experience may be captured and stored (hereinafter such information is collectively referred to as a “user profile”). In certain embodiments, multiple user profiles, from multiple participants or from a single participant navigating one or more interactive experiences (which may include a repeat navigation of the same interactive experience multiple times) may be collected, aggregated, made anonymous or otherwise analyzed or processed. As shown in FIG. 22, each of the user profiles, for example when one or more profile is available, may be presented as flow through the nodes of an interactive experience. For example, a user profile associated with flow 2216 represents that the user profile entered the interactive experience, at node 2202 and immediately branched out of the experience at node 2204. Flow 2216 might thus represent that a certain demographic of participants entering into an interactive experience immediately lost interest in the same. For example, an interactive shopping experience promoting women's shoes might result in a user profile representing a collection of men having an interest in the experience as represented by flow 2216, wherein the flow indicates that this population of men quickly lost all interest in shopping for women's shoes. In some instances, a flow may exit a node prior to the presentation of the node's content, as represented by flow 2222. In other instance, a user profile may proceed through the entirety of an interactive experience only to lose interest when a buying decision is presented, such as at node 2210, and the user profile exits with out purchasing the presented goods/services, as represented by node 2212 and flow 2224. User profiles and flows associated therewith may be collected based upon daily, weekly, total or any other time parameters. For example, an on-line mass advertising campaign, such as one provided on a television shopping channel presenting an interactive experience may collect user profile flows on a minute-by-minute basis.

As shown in FIG. 22, by capturing numerous user profiles, such as the collection of user profile flows represented by call-out 2218, with an interactive experience, an editor or other person involved in with an interactive experience may determine what works and what does not work. For example, an editor might conclude that a majority of participants suddenly lose interest in the interactive experience upon experiencing the content presented at node 2208. Thus, a marketer might decide that the messaging provided at or prior to node 2208 needs to be revised. A marketer might also recognize that those user profiles continuing past node 2208 and to node 2214 may be the demographic most interested in the experience presented and thus a marketer's target audience. Further, the marketer may determine that the user profiles exiting, without buying, as represented by node 2212 and flow 2214, require better messaging or more targeted messaging. Such marketer might then have an editor tailor the present or future interactive experiences to present an interactive experience that entices more user profiles to node 2214 and a buying decision.

It is to be appreciated that a mapping of user profiles to a plot structure, as shown in FIG. 22, may be applied to any experience in which one or more participants undertake a multi-step experience. Examples include testing, wherein a student's progress through a course of study may be depicted as the successful or unsuccessful completion of a certain study topics, as represented by each node. A branching from a node may represent where the student needed to access additional reference or remedial materials to successfully complete a quiz or test. When multiple users' performances with a given course of study are aggregated, an educator may be able to identify trends in teaching, reference materials or other factors that affect student performance. In addition to traditional primary through collegiate education, such students may include those in any corporate, industrial, military or other settings.

As shown by the various tabs 2200, in at least one embodiment, user profiles may be filtered and/or presented to an interested person based upon one or more filters, demographics or other criteria. In at least one exemplary embodiment, user profiles and the flows associated therewith may be filtered based upon such criteria as location (e.g., countries and cities), gender, visitors (e.g., all, few, time of day), systems (e.g., tablet computer user versus mobile phone user), referrers (e.g., whether a user was referred to the experience by another, for example, via a social media site), decisions and other criteria. As such, it is to be appreciated that any given implementation of an analytics tool may filter and/or present one or more user profiles based upon any given criteria.

Several revenue generating possibilities may be provided through one or more of the embodiments described above. For example, the storyline created by the user through the use of the design toolset or other editor interface may include one or more particular content, paths, episodes or other form of an interactive experience that may be experienced by a participant for free while the other content, features, paths etc. may only be open to subscriber level participants, or through micro-transactions, for example by paying per path. In at least one embodiment, to experience all of the content of the editor-created storyline, a participant may be required to provide some compensation to attain subscriber-status, as described above. In addition, any proceeds received for a particular editor-created interactive experience may be shared between the creator and a hosting entity (such as a hosting server or the developer of the design toolset). In at least one embodiment, the revenue generated from an editor-created episode or series may be split evenly with the hosting entity.

In those embodiments where the design tool may be used to create advertisements, personal videos and other multimedia experiences, a sliding fee scale may be utilized to obtain some form of revenue. For example, a large corporation may use the design tool to create one or more advertisements that may be accessed over the web or from a dedicated in-store kiosk. The corporation may be charged a large fee to use the design tool to create such advertisements. Alternatively, for editors that may use the tool to edit personal videos, a simple fee may be charged. In general, any size of a fee may be charged for use of the design tool, depending on several factors, such as the type of user, the multimedia content created through use of the design tool and any partnership agreements between the user and the design tool creator or publisher.

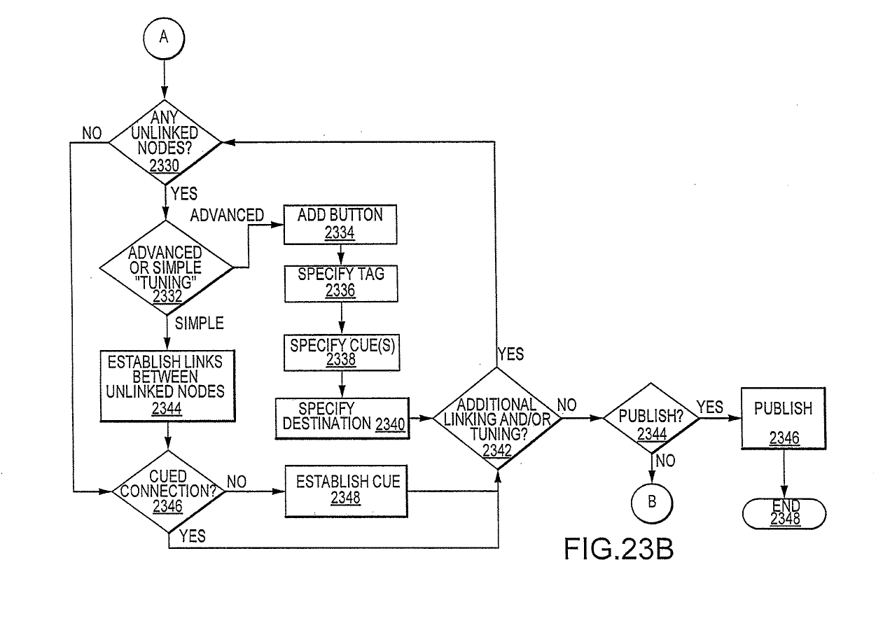

Referring now to FIG. 23A, one embodiment of a method by which an editor may create an interactive experience is shown. It is to be appreciated that an “editor” may be human, semi-human and/or non-human, such as a smart decision engine or other form of artificial intelligence executing on a compatible computing device which alone, or with human assistance and/or supervision, utilizes one or more analytics and/or other information, including but not limited to human input, to create an interactive experience that appeals to participants associated with at least one demographic, psychographic or other profile. As shown by operation 2300, the process generally begins by an editor accessing an interactive experience editing tool, such as exemplary project dashboard 2000 of FIG. 20. The editor may access any editing tool to which they have suitable access permission and rights.

Upon accessing the editing tool, the editor may select to edit an existing published or unpublished interactive experience (a “project”) or create a new project, as per operation 2302. If a new project is to be created, next, a project title is created, as operation 2304.

The editor may be queried as to whether to use a new or an existing plot, as per operation 2306. As discussed above, in one or more embodiments, a publisher may specify the plot an editor is to use for any given interactive experience. In other embodiments, an editor may be able to select from a catalog of existing plots. As per operation 2308 and without regard to whether a plot is specified or selected, the desired plot is populated onto the editing canvas, such as editing canvas 2116 of FIG. 21A.

Referring again to Operation 2306, when an editor is able to elect to create a new plot versus using an existing plot, and so elects to create the new plot, the process continues, in operation 2310, with a determination as to whether the plot is to be created free form, i.e., as content is selected, populated onto the canvas and links therebetween established, or in advance (i.e., wherein the plot structure is created with multiple nodes and linkages therebetween and content is subsequently populated into each node).

When the “In Advance” option is specified, the process proceeds with Operation 2312 with the plot being created on the editing canvas. Further, operation 2312 may also be invoked when with respect to an unpublished or published project; one or more changes to a plot are desired. As shown, for a published project selected for editing, the process may proceed with un-publishing the project, as per operation 2314, and then determining whether a modification to the plot is desired, as per operation 2316. Similarly, for an un-published project selected for further editing, a determination may be made as to whether to modify the existing plot, as per operation 2316. Thus, it is to be appreciated that the process may enable an editor to create and/or modify an existing plot structure for a project by placing multiple nodes onto a canvas and establishing linkages therebetween, as may occur for example per operation 2312.

Once the plot structure is created, or when implementing a “free form” plot creation approach, the process continues with identifying and/or uploading content that is to be made available to the editor for including, as desired, into the interactive experience, as per operation 2318. In at least one embodiment, such content may be identified and/or made available utilizing, for example, a content selection pane, such as content selection pane 2110 of FIG. 21B. Others methods of identifying and/or making content available may be utilized in other embodiments. In certain embodiments and/or implementations thereof, such as when an editor is constrained by a tool or publisher thereof as to the content, or source thereof, they may utilize for any given project, operation 2318 may be bypassed as no content identification may be needed. In other embodiments, an editor may be constrained only based upon technical constraints and/or access privilege constraints, such as copyright and digital rights management considerations, as to what content is made available and/or accessible to a project.

In operation 2320, content is associated with one or more nodes. In the case of a published or unpublished project containing multiple existing nodes that are already populated with content, operation 2320 may entail nothing more than an editor verifying the content in a given node is the desired content. In other instances, the editor may desire to substitute existing content with new or different content. With respect to a new project having a plot created “in advance,” or with respect to a pre-existing published or unpublished projected having one or more newly added nodes, as per operation 2312, operation 2320 may suitably include population of every such new or empty node with content. The population of content into nodes suitably continues until every node is populated with content, as desired.

As shown by operations 2322, 2324, 2326, and 2328, one process embodiment for ensuring each node is populated with content is to provide one or more manual or automatic checks as to whether all nodes are populated with content, as per operation 2322, and if not querying whether additional content is needed, as per operation 2324, if additional content is needed , a check is made as to whether “free form” editing is being accomplished, as per operation 2326, and a query may be made as to whether an additional node is needed, as per operation 2328. When no “free form” editing is occurring and additional content and/or node(s) are needed, the process may include providing one or more instructions, prompts or other indicators to the editor to input such node and/or as to a source of such content and uploading a link or the content itself into the editor, as per operation 2318.

For previously published, unpublished, new “in advance” and “free form” projects, the process of operations 2318, 2320, 2322, 2324, 2326, and 2328 continue until all nodes have been populated with content. It is to be appreciated that for at least one embodiment, a “free form” manner of editing may be used with respect to previously published and unpublished projects and/or “in advance” projects whenever an editor decides to position content on a canvas at a location not already containing a node connected to one other node. For “free form” projects, wherein the plot is created on without pre-existing node connections being specified, it is to be appreciated that a node may be automatically populated by the mere placement of the content (or a link thereto) onto the canvas. Once all nodes have been populated with content, the process may continue, via the “A” indicator with operation 2330, as shown on FIG. 23B.

While in at least one embodiment it may be desirable for all nodes to be linked, it is to be appreciated that an interactive experience may be presented to a participant as a selection of multiple parallel flows of content between which no branching occurs and at least one of such multiple parallel flows may include no branching within the flow, as may exist for example, for a piece of promotional or demonstration content with respect to which no interactivity is provided. As such it is to be appreciated that the exemplary process of FIGS. 23A and 23B desirably may apply to content flows having two or more nodes, between which at least one linkage exists.

As shown in FIG. 23B, the process may continue with a query as to whether any nodes presented onto an editing canvas for a given project are unlinked, as per operation 2330. If one or more nodes are unlinked, as between a given node and any other desired node to which the given node is to be linked, the process may continue with a query as to whether advanced or simple “tuning” of the project is to occur, as per operation 2332. As used herein, “tuning” of a project refers to specifying how a branching transition occurs between a first, precursor node and one or more second or subservient nodes. As discussed above, such transitions may occur automatically or upon user interaction. When advanced tuning is desired, one or more buttons may be specified on a precursor node, as per operation 2334. As discussed above with respect to the embodiment discussed with reference to FIGS. 21E, 21F and 21G, a button may be added to a node and configured such that it provides a tag providing a description of an interactive option being presented to the participant, such as the previously mentioned “Play Peruvian Gold” tag, a button may be configured with such a tag as per operation 2336. It is to be appreciated that a tag is not required in all embodiments for the process of FIGS. 23A and 23B.

A button added to a node that may be configured to include one or more cues, such as a cue-in and a cue-out, wherein a cue specified during a portion of the content presented by a precursor node, when a tag or associated interactive function is available for participant selection and/or use, as per operation 2238. As per tags, the adding of one or more cues to a button is not required for all embodiments of the process of FIGS. 23A and 23B.

A button added to a node may be configured to include at least one destination, as per operation 2340, wherein a destination identifies a node to which a participant may branch from the present, precursor node. It is to be appreciated, that in a looping presentation of content a node may be both a precursor to and subservient to another node. Also, it is to be appreciated that the designation of a destination nodes is not required for all embodiments of the process of FIGS. 23A and 23B as a button may not include a destination and may, for example, merely illicit a participant's response without such response instigating a change in the flow of presented or to be presented content.

Referring again to operation 2330, the embodiment of the process shown in FIGS. 23A and 23B may continue, upon a determination that a node is unlinked, and a decision to pursue simple tuning with respect to the unlinked node, as per operation 2332, with operation 2344. In operation 2344 for at least one embodiment described herein, an editor may establish links between a precursor node and a subservient node by graphically drawing a line connecting the two. In other embodiments, connections can be established, for example, by tapping a first time on a precursor node and tapping a second time on a subservient node. Any methodology for connecting two nodes may be utilized in one or more of the embodiments discussed herein.

Once a connection is established between a precursor node and a subservient node, the process may continue with determining whether the connection is cued, or un-cued, as per operation 2346. If the connection is not cued, and a cueing is desired, the process continues with operation 2348, by which an editor may specify when, and where in the content's elements, the precursor content and/or the subservient content are to begin and/or end, as described above for example with respect to the embodiment depicted in FIG. 21D. Once any desired cues are established, the process may continue with operation 2342 and a determination of whether any additional linking and/or tuning are desired.

Referring again to operation 2346, if the operation is already cued, as may occur when the subservient node is to merely be presented upon the completion of the entirety of the precursor node, the process may continue with a determination as to whether any additional linking or tuning is to be performed by the editor, as per operation 2342.

Referring again to operation 2330, when there are no unlinked nodes, or linked nodes that an editor desires to unlink or link differently, the process continues with operation 2346 and determining whether a cued connection is desired, as discussed above.

As such, the process of FIGS. 23A and 23B may continue with queries as to whether any additional linking and/or tuning is desired, as per operation 2342 and the linking and/or tuning of any so desired nodes, until all nodes and connections therein are established as desired by the editor. Additional linking and/or tuning may occur with respect to any node. For example, a second, third or other button may be added to a node. Similarly, one or more nodes or content segments may be populated onto a canvas and need linking therebetween and/or tuning thereof. As such, in at least one embodiment, the process continues from operation 2330 to operation 234, by way of advanced tuning operations 2332, 2334, 2336, 2338 and 2340 and/or simple tuning operations 2344, 2346 and 2348 until all desired content, and nodes established on a canvas for a project, are linked and tuned as desired by an editor. Further it is to be appreciated that some nodes for a project may be advanced tuned and others simply tuned with both, providing tags, cues and descriptors. For example, in at least one embodiment, simply tuned connections include tags that describe a subservient node by simply providing the title of the subservient node in a tag that is automatically presented at a pre-determined location and at a predetermined time to a participant during a presentation of the content associated with the given precursor node. As such it is to be appreciated that in at least one embodiment, the presentation content and whether such content was advanced or simply tuned by an editor may be undetectable and/or undeterminable by a participant. Also, other processes of plot creation, and the linkage and tuning may be used, in other embodiments, as desired and/or facilitated by any given project editing tool.

Referring again to the embodiment shown in FIG. 23B, once all desired nodes are linked and tuned, the process may continue with a query as to whether the project is ready to be published, as per operation 2344. If not, as shown in FIG. 23B, the process resumes for this embodiment with an inquiry as to whether additional content is needed, as per operation 2324 of FIG. 23A. It is to be appreciated, however, that the process could continue at any point along the process flows of FIG. 23A and 23B or at a non-presented process flow, such as an operation that might provide for additional tuning, linking or other processing of content for presentation during an interactive experience. When the editor determines that the project is ready for publication, the project is suitably published using any desired communications medium, service or techniques, as per operation 2346. At which instance the process is concluded with respect to the given project, as per operation 2348.

In the present disclosure, the methods disclosed may be implemented as sets of instructions or software readable by a computing device. Further, it is understood that the specific order or hierarchy of steps in the methods disclosed are examples of sample approaches. In other embodiments, the specific order or hierarchy of steps in the method can be rearranged while remaining within the disclosed subject matter. The accompanying method claims present elements of the various steps in a sample order, and are not necessarily meant to be limited to the specific order or hierarchy presented.

The described disclosure may be provided as a computer program product, or software, that may include a non-transitory machine-readable medium having stored thereon instructions, which may be used to program a computer system (or other electronic devices) to perform a process according to the present disclosure. A non-transitory machine-readable medium includes any mechanism for storing information in a form (e.g., software, processing application) readable by a machine (e.g., a computer). The non-transitory machine-readable medium may take the form of, but is not limited to: a magnetic storage medium (e.g., floppy diskette, video cassette, and so on); optical storage medium (e.g., CD-ROM); magneto-optical storage medium; read only memory (ROM); random access memory (RAM); erasable programmable memory (e.g., EPROM and EEPROM); flash memory; and so on.

The foregoing merely illustrates the principles of the invention. Various modifications and alterations to the described embodiments will be apparent to those skilled in the art in view of the teachings herein. It will thus be appreciated that those skilled in the art will be able to devise numerous systems, arrangements and methods which, although not explicitly shown or described herein, embody the principles of the invention and are thus within the spirit and scope of the present invention. From the above description and drawings, it will be understood by those of ordinary skill in the art that the particular embodiments shown and described are for purposes of illustration only and are not intended to limit the scope of the present invention. References to details of particular embodiments are not intended to limit the scope of the invention.

What is claimed is:

1. An apparatus, for providing a tool for editing an interactive experience, comprising:
a processor; and
a machine-readable storage medium communicatively coupled to the processor, the machine-readable storage medium storing a first computer-executable code that, when executed by the processor, instructs the apparatus to perform the operations of:
outputting for display on a computing device an interactive experience editing tool; and
receiving one or more inputs from an input device communicatively coupled to the processor, the one or more inputs selecting one or more features of the editing tool, wherein the one or more features edit content for presentation to a participant during an interactive experience.

2. The apparatus of claim 1 wherein at least one feature of the editing tool comprises an editing canvas and the operations further comprise:
identifying, on the editing canvas, a plot structure for the interactive experience.

3. The apparatus of claim 2 wherein the identification of the plot structure for the interactive experience further comprises the operations of:
selecting a first content segment and positioning the first content segment on the editing canvas;
selecting a second content segment and positioning each of the second content segment on the editing canvas; and
establishing a linkage between the first content segment and the second content segments.

4. The apparatus of claim 3 wherein the operation of establishing a linkage between the first content segment and the second content segment further comprises dragging and dropping a connecting line between the first content segment and the second content segment.

5. The apparatus of claim 2 wherein the identification of the plot structure for the interactive experience further comprises the operations of:
selecting a first node of the plot structure; and
specifying a tag to be associated with the first node, wherein the tag identifies a second node to which the interactive experience is to progress upon the satisfaction of a condition precedent.

6. The apparatus of claim 5 wherein the operations executed by the first computer-executable code further comprise:
specifying as the condition precedent a selection of a trigger point associated with a portion of a video image presented during a presentation of the interactive experience to at least one participant.

7. The apparatus of claim 1 wherein the one or more inputs are provided by a designer utilizing the input device, the input device associated with a computing device connected to the processor via a network connection.

8. The apparatus of claim 1, wherein the operations executed by the first computer-executable code further comprise:
calling a second computer-executable code, wherein upon execution of the second computer-executable code at least one feature of an application program is provided to an editor.

9. The apparatus of claim 8, wherein the feature provided includes an analytical tool configured for use in analyzing a progression by two or more participants through the interactive experience.

10. A machine readable storage medium storing a first computer-executable code that, when executed by a processor, instructs an apparatus to perform the operations of:
presenting, a computer image renderable display device, a content selection pane;
presenting, on the display device, an editing canvas; and
upon a selection and dragging of a first content segment and at least one second content segment, wherein each of the first content segment and the at least one second content segment are identified on and selected from the content selection pane, and the selected segments are dragged onto the editing canvas, generating a plot structure diagram for an interactive experience.

11. The machine readable storage medium of claim 10, wherein the first computer executable code, when executed by the processor, further causes the apparatus to perform the operations of:
presenting, on the display device, an editing window; and
presenting an option to add at least one button to the first content segment, wherein each of the at least one button identify at least one third content segment to which a progression of a plot is to proceed, during an interactive experience, from the first content segment upon a receipt of a signal initiated by a participant to the interactive experience, wherein the signal indicates a selection of a tag corresponding to the third content segment.

12. The machine readable storage medium of claim 10, wherein the processor is communicatively coupled to and remotely located from the apparatus.

13. The machine readable storage medium of claim 10, wherein the plot structure diagram is automatically populated with a linkage from the first content segment to the at least one second content segment.

14. The machine readable storage medium of claim 10, wherein the plot structure diagram comprises a hierarchical arrangement of content segments relating to an interactive experience.

15. The machine readable storage medium of claim 10, wherein at least one of the content segments comprises an identifier of an application program, whereupon selection of the application program identifier, the first computer executable code calls a second computer executed code, that when executed by a processor, provides during at least one additional functionality not provided by the first computer executable code during a presentation of the interactive experience to at least one participant.

16. The machine readable storage medium of claim 10, wherein the selection of and dragging to the content pane of the first content segment and the at least one second content segment occur automatically.

17. A computer implemented method for creating an interactive experience comprising:
populating, using a computer based tool, a plot for an interactive experience onto a digital canvas, wherein the digital canvas is generated by the editing tool and the plot includes at least one first node and at least one second node;
identifying, using the computer based tool, a first content segment and a second content segment;
populating, using the computer based tool, the first node with the first content segment;
populating, using the computer based tool, the second node with the second content segment; and
establishing, using the computer based tool, a linkage between the first node and the second node.

18. The method of claim 17 whereupon a participant accessing the interactive experience, the participant is directed from the first content segment to the second content segment based upon a satisfaction of a precursor condition.

19. The method of claim 18 wherein the precursor condition comprises a selection by the participant of a tag accessible through the first content segment.

20. The method of claim 19, wherein populating the plot onto the digital canvas comprises:
selecting at least two content segments from a content segment repository;
dragging and dropping the selected content segments onto the digital canvas; and
establishing a linkage by selecting an anchor point, dragging a line from the anchor point to another content segment and releasing the selected line wherein a linkage is established between each of the selected content segments with at least one other of the selected content segments such that upon linking of all of the selected content segments a hierarchy exists between a first of the selected content segments and a second of the selected content segments.
